(19) United States
(12) Patent Application Publication
(10) Pub. No.: US 2003/0196094 A1
(43) Pub. Date: Oct. 16, 2003

(54) Method and apparatus for authenticating the content of a distributed database

(76) Inventors: W. Daniel Hillis, Encino, CA (US); Bran Ferren, Beverly Hills, CA (US)

Correspondence Address: GLENN PATENT GROUP, 3475 EDISON WAY, SUITE L, MENLO PARK, CA, 94025, US

(21) Appl. No.: 10/289,995

(22) Filed: Nov. 6, 2002

(30) Foreign Application Priority Data
Apr. 10, 2002 (WO) PCT/US02/11434

(51) Int. Cl. H04L 9/00

(52) U.S. Cl. 713/179

(57) ABSTRACT

The invention comprises a combined public and private hashing scheme for authenticating the content of a distributed database. The public portion of the scheme is as performed in the prior art. When a portion of content is submitted to the database, a hash is computed using a publicly distributed hashing algorithm and a publicly distributed key, if a key is needed. The computation of the hash may be performed either by a registry computer system or the computer system of the individual submitting the content. Once the hash is computed, it is associated with the submitted content. Subsequent users of the submitted content can then authenticate the content locally, by computing a hash using the publicly available algorithm, and comparing the hash obtained to the hash associated with the content. In those instances where an extra measure of authentication is desired, or if unsuccessful verification of the public hash has called the authenticity of the content into question, the authenticity of the content can be determined via a private hash. The private hash is a second hash computed for the content upon submission to the database. The specific algorithm used to compute the private hash, and any keys used by this algorithm, are known only to the registry computer system. The authenticity of the content in question is determined by resubmitting the questioned content to the registry, where a hash is computed using the private hashing algorithm, and compared with the original private hash.

### BACKGROUND OF THE INVENTION

1. Technical Field

The invention relates to knowledge. More particularly, the invention relates to a method and apparatus for authenticating the content of a distributed database.

2. Description of the Prior Art

In a database containing information of public authorship, intended for public viewing, a key concern is preserving and demonstrating the authenticity of the information within the database. Prospective authors are more likely to contribute if they are reasonably certain that the material is faithfully distributed in its original form, and consumers of the information benefit from the reassurance that the information they are acquiring appears as originally created by the author.

One approach to ensuring the authenticity of such information is the computation and subsequent verification of a hash. In this approach, each portion of content added to the database is reduced, through a repeatable algorithm operating on the underlying data, to a shortened digital signature, or hash. The algorithm may incorporate a key or seed, that affects the value of the signature obtained. Changes to the underlying data can be detected by a subsequent hash calculation and comparison, using the same key.

In the case of a distributed database, where the database content is tracked at a central registry, but stored across a large number of physically separated servers, it is highly advantageous for the authenticity of the database content to be determinable locally, by the distributed servers or even the end consumer of the information. This alleviates the immense communications and computational loads that result if authentication of each portion of information accessed required consultation with the central registry.

One such approach is to create a hash for each portion of information deposited in the database. By creating this hash with a publicly available algorithm, and a publicly available key, if a key is needed, it is possible for subsequent users of the information to confirm its authenticity by computing a hash for the copy of the information they receive, and comparing it to the original hash.

Hashing algorithms are available, for example the MD5 algorithm developed by Professor Ronald L. Rivest of MIT, that ostensibly make alteration of the original data without altering the hash computationally infeasible. However, the invulnerability of such algorithms remains unproven. Furthermore, the vulnerability of such algorithms is increased if the key used by the algorithm, and the detailed nature of the algorithm itself, are publicly known. The reliability of an authentication scheme based on a single, publicly known hashing scheme is therefore uncertain.

It would be advantageous to provide a method and apparatus for authenticating the content of a distributed database that is reliable, yet that minimizes the computational burden placed on a central registry tracking the database content.

### SUMMARY OF THE INVENTION

The invention provides a method and apparatus for authenticating the content of a distributed database that is reliable, yet that minimizes the computational burden placed on a central registry tracking the database content. The invention solves the aforementioned problem by implementing a combined public and private hashing scheme to authenticate the content of a distributed database.

The public portion of the scheme is as performed in the prior art. When a portion of content is submitted to the database, a hash is computed using a publicly distributed hashing algorithm and a publicly distributed key, if a key is needed. The computation of the hash may be performed either by the registry computer system or the computer system of the individual submitting the content, with the latter minimizing the computational demands placed on the registry computer system.

Once the hash is computed, it is associated with the submitted content. Subsequent users of the submitted content can then authenticate the content locally, by computing a hash using the publicly available algorithm, and comparing the hash obtained to the hash associated with the content.

For most instances, verification via the public algorithm provides a sufficient level of authentication. In those instances where an extra measure of authentication is desired, or if unsuccessful verification of the public hash has called the authenticity of the content into question, the authenticity of the content can be determined via a private hash.

The private hash is a second hash computed for the content upon submission to the database. The private hash, i.e. the specific algorithm used to compute the private hash, and any keys used by this algorithm, are known only to the registry computer system. The authenticity of the content in question is determined by resubmitting the questioned content to the registry, where a hash is computed using the private hashing algorithm, and compared with the original private hash.

In addition, it is possible that the registry computer system could periodically authenticate the database content. Such verifications need not cover all content within the database to be effective because even a small possibility of detection would likely serve as a great deterrent to anyone considering tampering with the database content.

Thus, the combination public and private hashing scheme provides the desired level of authentication to all content users. Yet because only a small fraction of database users request the higher level of authentication from the registry computer system, the computational load placed on the registry computer system is minimized.

### BRIEF DESCRIPTION OF THE DRAWINGS

FIG. 1 comprises a series of block-schematic diagrams in which FIG. 1a outlines the problem of how to find accurate, relevant, and appropriate information; FIG. 1b outlines the problem of how to sort and identify useful information; and FIG. 1c describes the problem of how to identify what information needs to be learned and what is the best presentation format for that information;

FIG. 2 is block schematic diagram which shows the organization of information in accordance with the invention;

FIG. 3 is a block schematic diagram which shows a system configuration according to the invention;

FIG. 4 is a block schematic diagram showing an overall system and system elements according to the invention;

FIG. 5 is a block schematic diagram showing information flow within a system according to the invention;

FIG. 6 is a block diagram showing an annotation element according to the invention;

FIG. 7 is a block schematic diagram showing a presentation element according to the invention;

FIG. 8 is a block schematic diagram showing a business model for an information market according to the invention;

FIG. 9 is a block schematic diagram showing a profile element according to the invention;

FIG. 10 is a block schematic diagram showing multiple search bases in multiple views to reduce the search space according to the invention;

FIG. 11 is a block schematic diagram showing elements linking authorization, security, and commerce according to the invention;

FIG. 12 is a block-schematic/flow diagram showing a queued query process according to the invention;

FIG. 13 is a flow diagram showing a link display in which FIG. 13a shows a determination of display link and FIG. 13b shows a determination of search space according to the invention;

FIG. 14 is a flow diagram showing a multi-user, collaborative work flow for answering questions according to the invention;

FIG. 15 is a schematic representation of a user interface according to the invention;

FIG. 16 is a schematic representation of a document fragment with comments according to the invention;

FIG. 17a is a flow diagram showing the data object registry process according to the invention;

FIG. 17b is a block schematic diagram showing the structure of the hash table entry according to the invention;

FIG. 18 is a flow diagram showing the implementation of a padding technique according to the invention; and

FIG. 19 is a flow diagram showing a public/private hash scheme according to the invention.

### DETAILED DESCRIPTION OF THE INVENTION

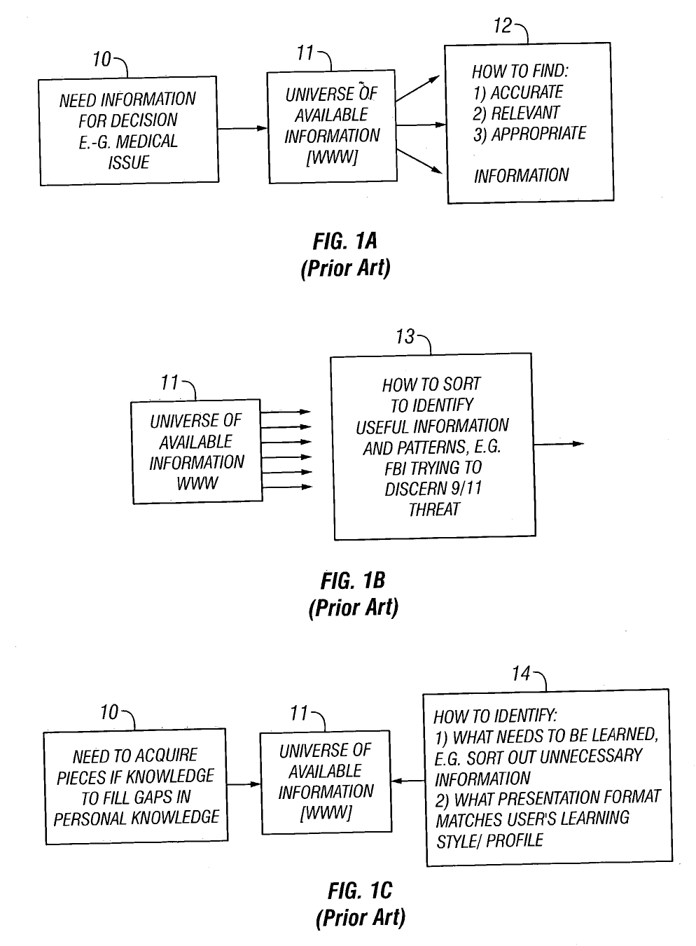

The invention herein is described in the context of a knowledge web, which is the subject of PCT patent application Ser. No. PCT/US02/11434, filed Apr. 10, 2002. While the invention herein is directed to solving various problems with regard to using, managing, and accessing information, three specific problems are identified in FIG. 1.

In FIG. 1a, a user 10 needs information to make a decision, for example with regard to a medical condition. The user accesses the universe of available information 11 which, in this case, could be the World Wide Web or other sources of information. A process 12 is required in this regard that would allow the user to find accurate, relevant, and appropriate information. In FIG. 1b, the universe of available information 11 exists and a process is required for searching the information to identify patterns of information that are useful, for example a government agency trying to identify a pattern of information that might predict a security threat.

In FIG. 1c, a user 10 needs to acquire particular pieces of knowledge to fill gaps in the user's personal knowledge. When accessing the universe of available information 11, a process is required that allows the user to identify what needs to be learned and what information is extraneous and therefore need not be considered. The process 14 must also present the information in a format that most closely matches the user's preferred learning style and/or intellectual interests.

The Knowledge Web—An Overview

Several of the key concepts underlying the knowledge web's approach to addressing the identified problems are detailed below.

A Broad Knowledge Base

A community of people with knowledge to share put knowledge into a knowledge base using a set of user tools. The knowledge may be in the form of documents or other media, or it may be a descriptor of a book or other physical source.

A central feature of the knowledge web is that each piece of knowledge is associated with various types of meta-knowledge about what the knowledge is for, what form it is in, and so on. Conceptually, the knowledge base is a centralized resource with possible private compartments, much like the Internet. Also like the Internet, it is intended to be implemented in a distributed manner.

The knowledge in the knowledge base may be created specifically for the knowledge base, but it may also consist of information converted from other sources, such as scientific documents, books, journals, Web pages, film, video, audio files, and course notes. As Marshall McLuhan observed, “The content of the new medium is the old medium.”

The initial knowledge within the knowledge web comprises existing curriculum materials, books and journals, and those explanatory pages that are already on the World Wide Web. These existing materials already contain enough examples, problems, eenough examples, problems, illustrations, and even lesson plans to provide utility to an early incarnation of the knowledge web.

The knowledge base thus represents:

Knowledge (online content or references to online or offline content), and

Meta-knowledge, created at the time of entry, accumulating over time, and indicating, for example, the usefulness of the knowledge, reflecting user opinions of the knowledge, certifying the veracity of the knowledge, providing commentary on the knowledge, or indicating connections between the knowledge and other units of knowledge.

Collaboration and Community Involvement

One aspect of the knowledge web is peer-to-peer publishing. The task of recording and sharing the world's knowledge is so monumental that peer-to-peer publishing by a very large number of people is the preferred manner in which to accomplish it. One of the reasons why the Web and Internet news groups have enjoyed such runaway success is that they allow people to communicate with each other directly, without intermediaries. This basic human desire to share knowledge is also what drives the creation of the knowledge web.

Many people have specialized knowledge about certain topics, and know how to teach them especially well, but there are few easy ways for them to share that information effectively with a large audience, short of teaching a course, writing a textbook, or developing a television special. With the knowledge web's authoring tools, anyone with knowledge to share can publish short pieces, such as a single explanation of a concept—an effort comparable to creating a Web page. These explanations are the basic building blocks of the knowledge web.

While the knowledge web builds on systems such as the World Wide Web, Internet news groups, libraries, professional societies, books, and refereed journals, it allows an even more generalized form of linking than the World Wide Web. In the knowledge web, the author as well as readers can create annotations. These annotations can then be used for advanced features such as author credits, usage tracking, and commenting, that the Web lacks. Users are also able to add annotations to explanations connecting them to other content, suggesting improvements, and rating their accuracy, usefulness, and appropriateness. Such feedback enhances the value of the knowledge web, keeps it current and useful, and eventually makes its way back to the original authors, so that they can use it to improve their explanations.

This ability of users to comment, filter, and review the content of the knowledge web solves one of the serious problems with peer-to-peer publishing—that of quality control. While publishers of textbooks and journals provide editing and selection services, the information on the World Wide Web is often irrelevant, badly presented, or just plain wrong (and that's not including the pornography and the propaganda). The knowledge web's peer review infrastructure also leads the way for third-party certification of content, further enhancing the knowledge.

Individualized Learning

The knowledge web allows for learning tailored to an individual learner. This is accomplished through the use of a tutor that customizes a user's learning experience based on a user learning model. The tutor handles the key problem of presenting the right information to the user at the right time. The knowledge web's tutor does not create or transform the knowledge itself, but merely maps a path from what a user already knows to what he needs to learn.

The learning model for an individual user combines a user profile, reflecting information on the current knowledge, needs, capabilities, and preferences of the user, with generalized knowledge about how people learn. The tutor draws upon the learning model and the meta-knowledge stored in the knowledge base to allow learning in a manner most fit for the user. In its simplest form, the tutor follows the explicit instructions of a human teacher on how to teach a certain body of knowledge to a certain type of person.

For example, the tutor may show that a given user has a firm understanding of calculus, a general understanding of Newtonian physics, and is completely mystified by quantum mechanics. The model may also include a much more detailed model of certain topics that are of particular importance to the user. For instance, in the case of a medical practitioner, it knows not only the physician's specialty, but it also knows with which recent discoveries, within that specialty, the physician is already familiar.

Most significantly, the user profile of a user is continually updated, allowing the tutor to become better acquainted with the user over time. It knows what the user already understands and what he is ready to learn. It knows the user's learning style: whether he prefers pictures or stories, examples or abstractions.

### EXAMPLE 1

A Lesson from Dr. Feynman

If a user wanted to learn about the principle in quantum mechanics called Bell's Inequality, he has several options. The user could read about it in any of several books on quantum mechanics. He could read the original paper describing it, or any of several papers that discuss it. The user could read articles on the Web that discuss Bell's Inequality. Which of these options is right? Are there other options to learning that he is unaware of? Is there a learning path he should take that would prepare him to understand Bell's Inequality? A personal tutor, if the user had one, might be able to help.

For example, there is a short film of Dr. Richard Feynman explaining Bell's inequality. Most people have little interest in quantum mechanics and no interest at all in understanding Bell's inequality, and would not understand or be interested in this film. On the other hand, most quantum physicists already understand Bell's inequality, and would learn little from Feynman's explanation.

However, if the user is a student who is just learning quantum mechanics, who has just mastered the necessary prerequisites, Feynman's explanation can be exciting, startling, and enlightening. It not only can explain something new but can also help the user make sense of what he has recently learned. The trick is showing the film clip at just the right time to the person who can best appreciate it. A good human tutor who understands the student's background and preferences can do just that.

The knowledge web's tutor seeks to emulate this personalized level of presentation. In its simplest form, the tutor is a knowledge base access tool that takes user preferences into account. In more complex versions it takes advantage of the meta-knowledge in the knowledge web and the user learning model to plan what information is presented and how.

The following is a list containing examples of methods that the tutor uses:

The tutor plans its lessons by finding chains of explanations that connect the concepts the user needs to learn to what he already knows.

The tutor creates a map of what the user needs to learn.

The tutor chooses the explanatory paths that match the user's favorite style of learning, including enough side paths, interesting examples, multimedia documents, and related curiosities to match his level of interest.

Whenever possible, the tutor follows the paths laid down by great teachers.

If an explanation does not work, and consistently raises a particular type of question, then the tutor records this information in the knowledge base, where it can be used in planning the paths of other students.

Once the user has learned the material, the tutor updates the user profile to reflect the newly acquired knowledge. Because the tutor knows which subjects the user is and has been interested in, it can reinforce the user's learning by finding connections that tie these subjects together.

The tutor becomes acquainted with the user because it has worked with the user for a long time.

When an explanation does not work, the tutor tries another approach. The user can probe an area of learning further, request examples, and give the tutor explicit feedback on how it is doing. The tutor then uses all these forms of feedback to adjust the lesson, and in the process it learns more about the user.

### EXAMPLE 2

The Physician's Dilemma

Imagine that the user is a physician who wants to treat a patient who has an unusual disease. A standard medical education probably treats the topic superficially, if at all. The user is thus faced with a few unsatisfactory alternatives. He might consult a specialist, but if he does not know much about the field it is difficult to know what kind of specialist is needed. The user could try reading a specialized textbook, but such a textbook is likely to be out of date, so he also has to find the relevant journals to read about recent developments. If he finds them, they almost certainly are written for specialists and are difficult for the user to read and understand. Given these unsatisfactory choices, the user may go ahead and try to treat the disease without the benefit of the best knowledge.

With the knowledge web, one can make the transition from a qualified general practitioner lacking specialized knowledge to a more fully informed specialist in several ways. The tutor might provide the best path for the user to gain knowledge about the condition and its treatment. It might put the user in touch with a nearby specialist. It might provide him with a forum to add his knowledge on this extremely rare condition for others to use.

Other Aspects

The knowledge web also provides features lacking or deficient in the World Wide Web, such as copyright protection, data security, permanence, and authentication.

The World Wide Web has demonstrated that many authors are willing to publish information without payment, but it does not give them any convenient option to do otherwise. The knowledge web provides various payment mechanisms, including subscription, pay per play, fee for certification, and usage-based royalties, while supporting and encouraging the production of free content.

The support infrastructure for payments allows different parts of the knowledge web to operate in different ways. For instance, public funding might pay for the creation of curriculum materials for elementary school teachers and students, but specialized technical training could be offered on a fee or subscription basis.

Another model that is supported is a micropayment system, in which a user pays a fixed subscription fee for access to a wide range of information. Usage statistics would serve as a means to allocate the income among the various authors. This system has the advantage of rewarding authors for usefulness without penalizing users for use. The ASCAP music royalty system is an example of how such a system might work.

Conclusion

With the knowledge web, humanity's accumulated store of information will become more accessible, more manageable, and more useful. Anyone who wants to learn is able to find the best and the most meaningful explanations of what he wants to know. Anyone with something to teach has a way to reach those who want to learn.

Knowledge Web Structure and Operation

As described in the preceding overview, the invention provides a system to organize knowledge in such a way that users can find it, learn from it, and add to it as needed.

The presently preferred embodiment of the invention achieves this goal with a system most simply considered as having four principal components:

a knowledge base,

a learning model and an associated tutor,

a set of user tools, and

a backend system.

The invention also preferably comprises a set of application programming interfaces (APIs) that allow these components to work together, so that other people can create their own versions of each of the components.

Knowledge Base

The knowledge base is composed of knowledge and meta-knowledge.

Knowledge

Each of the principal components of the presently preferred embodiment of the invention makes use of a knowledge representation scheme that organizes the knowledge within the knowledge base into explanations, topics, and paths. The explanation is the basic building block of knowledge in the system. An explanation is a human-readable piece of content such as text, audio, video, or interactive media. Explanations are organized into topics, and are connected by paths.

Explanations

Most of the information in the knowledge web is in the form of explanations. An explanation is a unit of content that helps the user understand one or more topics. An explanation may be a piece of text, an illustration, a segment of audio or video, or something more complex, such as an interactive Web page. Some explanations explain through instruction, while others give definitions, demonstrations, or examples. Explanations may be labeled with annotations providing meta-knowledge identifying their type, source, relevancy, etc.

A single explanation may explain several topics, and a single topic may be explained by many explanations. Every explanation has links to the topics that it explains. Explanations also have links to their prerequisites, that is, to the topics that represent the prerequisite knowledge. If a user needs a certain level of knowledge about a particular topic in order to understand an explanation, then the explanation has a link to that topic, indicating the level of knowledge required.

Topics

A topic is a cluster of concepts that a user might want to learn at the same time. The topic might be something very specific, e.g. “How to Change a Tire,” or it might be something very broad, e.g. “Chemistry” or “Configuring UNIX Systems.” An academic course is likely to cover a topic, but every item in the course outline is also a topic of its own. Topics typically have multiple subtopics included within them. A subtopic may be part of many topics.

The smallest type of topic is the testable unit of knowledge or TUK. The TUK is a very simple topic that contains no subtopics. It represents a single idea or a fact. It is so simple that the user either knows it or not. There are no degrees of understanding. A TUK is testable in the sense that it is possible to ask a question that tests whether the user knows it or not.

The knowledge web uses topics to organize knowledge. For example, a user of the system specifies what he wants to learn in terms of topics. Topics are also used to map an area of knowledge, to show the user a map of the gaps in his knowledge or a map of what is to be learned. The system also keeps track of what the user knows in terms of topics. It may know for example that the user is an expert at “Configuring UNIX Systems” and that the user is only a novice at “Chemistry.” The system has a representation of how important each of the subtopics is to the topic, and which subtopics correspond to which degrees of understanding. It also has a representation of what parts of the topic the user knows.

Paths

A path is a way of describing a sequence of explanations and queries, with possible branch points. Paths are used to encode information about ways to learn a topic. As with an explanation, a path is linked to the topics it explains and topics it depends on as prerequisites. In fact, a path may be thought of as a kind of composite explanation. Some of the explanations in a path may be commentaries that guide a user along the path. For example, there may be a description of the topics to be covered in the path, or reviews of what has been learned. This type of commentary explains the path, not the content, so unlike a normal explanation it is not linked to a topic, but only to the path of the explanation.

A path can contain branch points that are based on answers to queries. These branches can ask the user for explicit directions, such as “Do you want to see another example?” or alternatively the branch may be a test of the user's understanding. A query always includes a set of sample answers. In the simplest case, these answers are presented to the user for a multiple-choice response. A query can also be set up so that the user gives a free-form response. In this case, the response is matched against the possible answers using a pattern-matching algorithm.

A path may also contain additional information about how the sequence is presented. For example, the path may constrain the timing of the presentation, or the layout of explanation and test questions on a page. This information is represented by annotations on the links of the path, described later.

Meta-Knowledge

The meta-knowledge within the knowledge base consists of user annotations and document metadata.

User Annotations

User annotations are associated with explanations, topics, paths, or other annotations and provide further information relevant to the explanation, topic, path, or annotation. Annotations do not modify the annotated content, but merely add to it.

The author of the annotated content creates some of the annotations; third parties create others. For example, the author of an explanation may add an annotation to link a list of frequently asked questions (FAQ's) or may support an associated discussion group. The author may also add annotations indicating that this explanation is only available to users with certain permissions.

Third parties add annotations, whether explicitly or implicitly, through their use of content. For example, usage statistics, a simple example of an annotation, are added automatically as users access content. Annotations are also added to reflect the popularity of content, or its appeal to learners of various types. In addition, certification authorities may add annotations certifying or questioning the correctness or the appropriateness of content.

Another type of statistical annotation that may be collected is a simple poll indicating whether a user liked the explanation. Feedback statistics may also be recorded for other usage information, such as how frequently specific questions are asked.

Third parties can also make annotations explicitly. For instance, a user can add an annotation designating a related explanation, or an annotation offering editorial comment.

Document Metadata

Several annotations to an explanation, topic, path, or annotation may be added automatically at the time of creation, such as those identifying the creation date, authorship, or language. This form of annotation is referred to as document metadata.

As used herein, the act of annotation refers generally to the creation of meta-knowledge, encompassing both user annotations and document metadata. Similarly, annotations refers generally to instances of both user annotations and document metadata.

Learning Model and Tutor

The tutor makes use of the learning model and the knowledge base to help the user find the topics and explanations that are most helpful. For example, the tutor uses an awareness of the user's age, language preferences, and reading level to filter and sort explanations. It also uses information on which authorities the user trusts, and which authors he likes. This information is also used to filter and sort explanations.

The tutor also knows about specific topics that the user learned or demonstrated knowledge of in the past. It has information about the user's interests, both in terms of topics and presentation. It knows the user's preferences for words, pictures, audio, video, or interactive programs. It also knows whether the user likes examples, definitions, equations, diagrams or stories. It may even know whether he likes to stay focused or wander, whether he prefers to explore wide or drill deep. All this formation helps the tutor present information in a way that the user can most easily understand it. Preferably, all user specific data is private and inaccessible to others.

In some cases the user may not be looking so much for a specific piece of knowledge, but for a credential or a skill. The tutor is also able to help the user find these. For example, there may be a topic corresponding to “Passing the New York State Bar Exam” or “Operating a Caterpillar Model D3 Bulldozer.” These topics not only link to the knowledge the user needs to pass the test, but also to courses that lead to certification. In many cases, learning the factual knowledge is only part of the process.

Once the user has chosen what to learn, the tutor helps the user choose how to learn it. In the simplest cases, this may be a single explanation. In more complex cases, the tutor finds chains of explanations that connect what the user wants to know to what is already known. The tutor takes into account the user's personal tastes, language, sensibilities, and learning style in its choice of content. It also takes into account the statistical experience of others. It knows what explanations have worked in the past, and it also finds and takes advantage of paths and annotations laid down by teachers.

As with choosing the topic, choosing explanations is an interactive process between the user and the tutor. In the simplest cases, the user can just choose from a list of sorted options. In more complex cases, the process is more like planning a course of study. For instance, the user may want to plan which material is covered, how long the user is willing to spend, and in what sequence the user wants to learn things. This gives the user an outline of the plan of study.

The tutor can also test the user's knowledge by asking the user questions. How often it does this depends on the user's personal preferences. Such questions are partly to reinforce what the user has learned and partly to verify that the user has learned it. If the user has not learned a concept, the tutor may suggest other explanations. If the user is following a path created by a teacher, the teacher may have included a question, and suggestions on where to go next that depends on the user's answers. The teacher can use wrong answers to steer the user down a branch of the path that helps the user clear up a particular misunderstanding.

The tutor acts as a guide, not as a director. Its job is to present the user with the options, and recommend those that come closest to fitting the user's needs. It is also the tutor's job to keep the user informed about where the user is, and where the user might want to go next.

User Tools

The knowledge web provides two principal sets of user tools to access and modify the knowledge base—viewing tools and authoring tools. The viewing tools provide the user access to and a limited ability to modify the knowledge base, whereas the authoring tools allow for more rapid and more extensive creation and modification of content.

Preferably, these tools are implemented as software systems.

Viewing Tools

The viewing tools provide the primary interface between the user and the knowledge web. The viewing tools can be thought of as an extended Web browser, with support for specialized operations for the knowledge web. The presently preferred implementation of the viewing tools is a browser with an added set of extensions. The viewing tools supports three basic activities: knowledge base visualization, content display, and annotation. The viewing tools provide specialized user interfaces for each of these three activities.

Visualization Interface

One goal of this aspect of the invention is to develop a better way for a user to visualize and navigate a connected web of knowledge. This aspect of the invention allows the user to navigate through the links, see patterns in the connections, and reorganize the information according to multiple navigational schemes. It allows the user to see detailed local information, and also see how that information fits into a broader global context.

Visualization of the knowledge base typically begins with the selection of a topic or topics that a user wants to learn about. In the simplest cases, this can be accomplished by the user naming a topic. This may be done by the user entering a word or phrase into a topic-search engine.

The visualization interface then displays a map of the area of topic space the user selects, showing what the user already knows and what is knowable. On the topic map, the space of topics and subtopics is illustrated as a two-dimensional landscape, with borders, landmarks, and links showing relationships between topics. A coloring scheme shows the user's prior knowledge and the relative importance of the topic.

As described herein, the tutor can play an important role in generating a map that is meaningful to the user. Because the learning model provides the tutor with an understanding of what the user already knows and how he prefers to have information presented, the visualization interface is able to create a map specifically for the user.

The visualization interface allows the user to display and navigate the topic map. The way that the map is drawn and colored in context depends both on what the user is trying to learn and on what others the user trusts have judged to be important. The map allows the user to get a feel for the size of each topic, and how long it takes the user to cover. It also shows paths that the user has traveled before and paths that others have traveled before. The visualization interface allows the user to move through the topic space by panning, zooming, or leaping from topic to related topic. The user can zoom into the relevant topics, look at their subtopics and mark the things that are of interest, or that are already known.

The system may also provide a simulation of a three-dimensional navigational space that the user can “fly” though, by moving forward/back, right/left, or up/down, or rotating. It is anticipated that the user will not be permitted to use the rotation function, as it would likely result in disorientation of the user. In this navigation space there are a number of graphical objects: some are three-dimensional, and some are animated. Some of the objects have sounds associated with them that the user begin to hear as he draws near. Between objects are links, representing the relationships between the concepts they represent. The links are initially nearly transparent, but as the user moves nearer an object, the links associated with it become more visible, then fade as the chain of connections extends away from the object. As the user approaches a link, links of that type become more visible.

The objects are arranged in space in a systematic way. For instance, the vertical dimension may represent historical time, and the horizontal dimension may represent a theme. The organization scheme is not fixed. When the scheme is changed, the objects reorganize themselves in a new order.

The user moves through this space to find and examine objects of interest, to visualize their relationships, and to visualize the context into which they fit. The space is rich in color, depth, texture, motion, and sound; rich in a way that adds meaning and helps understanding.

The visualization interface uses the spatial metaphor at all levels of the topic tree. At the higher level the map has been carefully drawn by human mapmakers. Topics such as “Chemistry” and “Physics” maintain a dependable relationship to one another in the landscape. This allows the user to get to know an area of the topic landscape, and learn to navigate through it. At the high level, the topic map changes slowly. At the lower, more detailed levels, the topics such as “Internet addressing schemes” and “Current Events” are more dynamic, and the topic map begins to look more like a web of connections.

Display Interface

Once the user has decided what he wants to learn, the display interface presents the information, as directed by the tutor. The display interface presents explanations to the user as a sequence of presentations, much like a linked sequence of Web pages. The display interface supports most of the familiar Web browsing functions, such as forward and back (a.k.a. next and previous) and hypertext links. It also supports the same range of media types as a conventional Web browser, including text, images, audio video, and various forms of interactivity. In fact, the display interface can also function as a Web browser, and it does so when a link takes the user to pages on the World Wide Web.

Within the knowledge web, the display interface can provide better navigation than a Web browser. For instance, it has a “Where-am-I” button that, preferably in conjunction with the visualization interface, orients the user within the path or the topic space, and a “Return-to-Path” button that can bring a sidetracked user back to the main path.

The display interface supports still other functions that cannot be supported on an ordinary Web browser because of the limitations of the World Wide Web. One of the most important is the “About this” button. For any item in the knowledge web, it shows the user who the author is, when it was written, who has certified it for what purposes, how often it has been used, etc. It also shows the annotations, made by the author or third parties, indicating related material, references, associated discussion groups and user feedback. Again this material is sorted and filtered according to the user's personal preferences.

The display interface can also take advantage of annotation to provide more meaningful interaction with the user. For example there are buttons for the functions “Show me a picture,” “Give me an example,” or “Give me a different explanation.” The user can also ask for the definition of a word, in which case the display interface shows the user the definition that makes sense in the context of the particular topic at hand. The display interface also supports the ability to ask a question. Questions are matched against the list of frequently asked questions (FAQ's) associated with the explanation, and also against more general FAQ lists associated with the topics. The question can also be forwarded to the author of the content or posted on a discussion group.

Annotation Interface

The annotation interface allows the user to modify the knowledge base through the addition of annotations.

The process of viewing content in the display interface causes some annotations, such as user statistics, to be updated automatically. Alternatively, a simple poll indicating whether a user liked an explanation may be conducted. This polling feedback may be generated by a voting scheme, using a simple pair of “thumbs up/thumbs down” in the annotation interface. Voting may be made anonymous by an encryption scheme that hides the identity of the user, while guaranteeing that a user can vote only once. Feedback statistics may also be recorded on other usage information, such as how frequently specific questions are asked.

Users can also make annotations explicitly. For instance, a user can add a link to a related explanation or Web page. A link of this type contains descriptive information about how it is related. An annotation of this type must have an author who takes responsibility for it. Only the author of an annotation of this type can modify or delete it.

Authoring Tool

While the viewing tools can be used to add annotations to existing content, most new content is created using the authoring tool. The authoring tool can be used to convert an existing document, such as a textbook, article, or Web page, into an explanation for the knowledge web. It can also be used to create an instructional path with branches, quizzes, commentary, etc.

Creating an Explanation

A knowledge web explanation is distinguished from ordinary Web content by annotation and registration. Registration means that the page has been declared to exist as part of the knowledge web. This is accomplished by submitting it to a registration server. Before content can be registered, specific annotations may be required and various options specified. For an explanation, the required annotations include the author, creation date, URL identifying where it is stored, a list of the topics the explanation explains, and information specifying language and media type.

To aid in the process of registration, the authoring tool provides a mechanism for helping to find the topics corresponding to an explanation. The author specifies a topic to which an explanation applies using the topic chooser. The authoring tool then presents the author with a list of specific topics, sorted according to how well they match the explanation. It may also present the author with a menu of subtopics that more exactly match the explanation. The author may choose one or more of the subtopics, and even narrow down the range to specific testable units of knowledge that are explained. Once the list becomes manageable the author can check off the appropriate topics. The author may also create new topics, as described below.

There are also a number of annotations that may be specified at the time of registration. For example, the author may wish to restrict access to the information to users who have been cleared through a specified permissions authority. The author may want to support an associated discussion group, or may want to be an informer of questions that are asked by users. The author may link search keywords for locating the explanation or identify it as being relevant to certain topics. An author may also link an explanation as having content inappropriate to children. The authoring tool also provides an easy way for the author to link frequently asked questions and associated answers.

The authoring tool registers the explanation by transmitting registration information to the registration server, and storing the content and annotations in a suitable location within the knowledge base. At the time of registration, the author may also choose to submit this explanation to various certification authorities for consideration. The authoring tool provides support for such submissions.

Creating a Topic

Normally the author of an explanation tries to link explanations to existing topics. For those instances when this is not possible, a new topic may be created. The authoring tool includes an interface for visualizing the knowledge base, preferably similar to that in the viewing tools, with a search engine and topic browser. To create a new topic, the author specifies its relation to one or more existing topics. The author specifies any subtopics within the topic and preferably identifies what knowledge is required for several levels of mastery, such as familiarity, understanding, and expertise. A short definition of the topic must also be specified, and optional search terms may also be included.

Creation of testable units of knowledge (TUKs) is even simpler because TUKs are topics with no subtopics, and only one level of understanding. A TUK can often be stated in a single sentence. Creating a TUK can be as simple as highlighting a single sentence in the explanation, or the clicking of a button. When a TUK is created, the authoring tool tries to parse the sentence and creates a diagnostic test question. This suggested question can be accepted or rejected by the author.

Once a topic is registered, it is included immediately in the topic database. Later, it may be merged with another topic. At any time, authorized individuals are able to edit the topic tree and collapse several topics into a single topic, or to split existing topics. The same rules apply to TUKs.

When converting an existing document into a series of explanations of the knowledge web, the outline of the document often corresponds closely with the list of topics that are covered. This is particularly true of a textbook or a technical manual. The authoring tool includes a mechanism for mapping an existing outline onto a topic tree. It helps the author find existing topics that correspond to the outline items, and existing TUKs that correspond to the explanation. It also helps the author create any TUKs and topics that do not already exist. Because it is working within the context of a hierarchy, broad topics identified at the top of the hierarchy can help inform the search process for the more specific topics below.

Creating a Path

Just as explanations encode knowledge, paths encode information about how to learn that knowledge. A teacher, for instance, can create a path to guide a student by specifying a sequence of explanations, which may include documents, queries, and commentaries. The authoring tool helps the teacher specify each explanation in the path. It also allows branches to be added based on queries. A different branch of the path may be linked to each answer of the query. In addition the tool gives the teacher control over how the information is presented on pages. As an aid to the author, the authoring tool automatically produces a flow chart of the path, showing all links and branched and list of TUKs and topics that are explained and a list of prerequisites.

The authoring tool provides a simple way to create a query, as a branch point in a path. The required information for a query is similar to an explanation. The same tool is used to create any query, whether it is a test question, or a question to determine the branch of a path. In addition the query must have a set of possible answers, one of which is specified as correct. The query may be tagged as a multiple-choice question, in which case the answers are presented to the user in randomized order as choices. If the question is not a multiple choice, a pattern matcher is used to pick one or more of the answers to be verified by the user. In this case, matching patterns may be explicitly associated with each of the answers. If such patterns are not specified, the answers themselves are used as patterns.

Once the path has been created, the authoring tool can be used to register it.

Backend System

Generally, the backend system supports access to the structured knowledge within the knowledge base. The detailed architecture of the backend system is a central feature of the present invention, and is accordingly described below in greater detail.

Backend System Architecture

The backend system addresses the problem of how a very large amount of loosely structured data can be stored, organized, and shared among a large and diverse group of users. To better illustrate the backend system of the present invention, the system is described in detail with respect to the presently preferred embodiment of the invention, which provides a distributed, scalable architecture that implements a database using standard commercially available components.

In this embodiment of the invention, the knowledge base is viewed as a database represented as a labeled graph that can be accessed and modified by thousands of users concurrently. In this approach, the knowledge within the knowledge base is viewed as data, and the meta-knowledge within the knowledge base is viewed as metadata. Entities of content, for example explanations, topics, paths, and links, are viewed as data objects. In the labeled graph view of the database, the nodes of the graph represent data objects, and the associated metadata are represented by links connecting those nodes. Finally, the various user tools provide a front end to the database.

The data is stored on one or more data servers, and information about the data is maintained by one or more data registries. The servers and registries are preferably implemented as a distributed application that runs on servers connected by a network. Herein, the backend system is described in terms of a single data registry and a large number of data servers. Each of these servers may actually be implemented as a distributed application that caches information across multiple machines, but this aspect of the implementation is ignored for purposes of this discussion.

Users may access the database through a network using the front ends. The front ends talk to a metaweb server which has access to the user's security profile, and access to the registry. With this information, the metaweb server obtains the location of the data objects requested by the user, retrieves them from data servers, and assembles them for manipulation by the front end.

Data Objects

All data and metadata in the system are represented as nodes and links, which may be classified into the following types of data objects.

Data Nodes

The system supports data generally in multiple formats, and in multiple data types. Examples of data types include text, image, sound, video, and structured data. Also, the system supports the storage of data in multiple locations, both online and offline, and provides identification information for the data, including location, data type, and data format, and other attributes as available.

In the case of online data, support is provided for storing redundant copies of data at multiple online locations. In the case of offline data, robust identifiers such as an ISBN number, a Library of Congress classification, or document citation are provided wherever possible to enable the user to negotiate access to the element in some way.

Concept Nodes

Concept nodes are internal objects that are used to group or otherwise classify data objects. Examples of concept nodes include nodes representing categories, entities, and classes of data. Concept nodes are treated similarly to data objects in that links may originate or terminate in them. Users are able to search or navigate the database using concept nodes.

Labeled Links

The system supports labeled links of many different types. The types of links are centrally managed and limited to a known number of specific types. Examples of types of labeled links include links representing membership in categories, links associating data with specific objects, links tagging document metadata, and links representing user annotations. Provision is made for addition of labeled link types based on user needs and system growth.

Links are directional. Given a data object it is always possible to determine all links that connect from the data object to another data object. Finding all links that connect to the data object may require search. Links may connect from data nodes or concept nodes to data nodes, concept nodes, to numbers or to text strings.

Labeled Graph

The relationships between the data objects may be represented by a labeled graph.

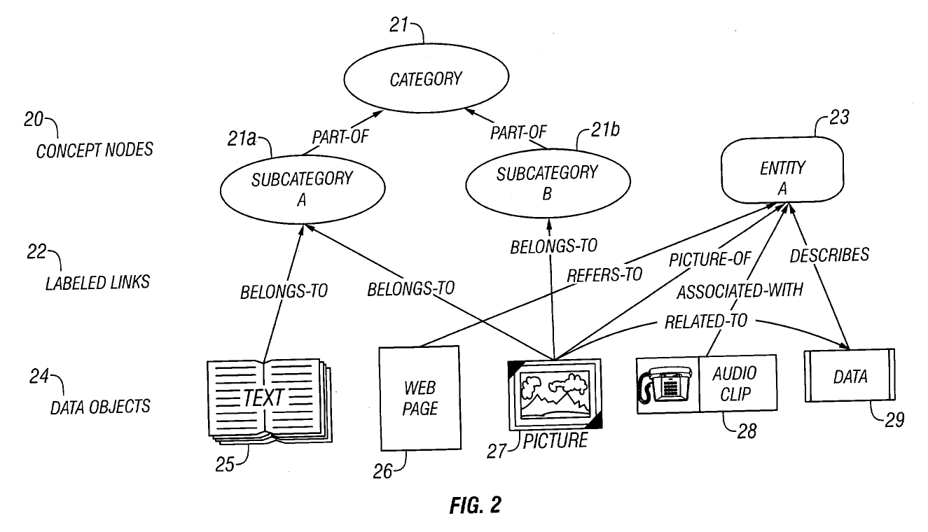

FIG. 2 shows a database represented as a labeled graph, where data objects 24 are connected by labeled links 22 to each other and to concept nodes 20. For example, a concept node for a particular category 21, contains two subcategories 21a, 21b that are linked via labeled links “belongs-to” and “related-to” with text 25 and picture 27. An entity 23 comprises another concept that is linked via labeled links “refers-to,” “picture-of,” “associated-with,” and “describes” with Web page 26, picture 27, audio clip 28, and data 29.

System Components

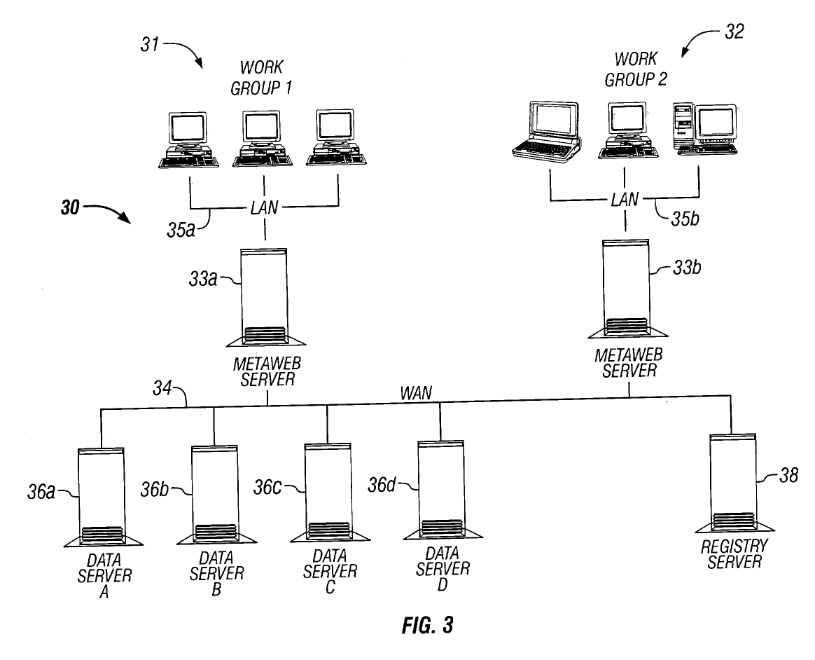

FIG. 3 shows a sample configuration containing several principal components of the system. These components may be generalized or implemented in various forms and configurations.

Front Ends

Users access the system through a network via applications, for example on workstations or PCs. These components are external to the system itself, although the system provides APIs that enable software running on these workstations to communicate with the system.

Registry

Each object in the system is registered in a registry. The registry keeps track of where the data and metadata associated with a data object are stored. Every data object has a unique signature and index, which is used to access the data object within the registry. Using the index, the system locates the data object in the registry and assembles components of the data, metadata, and other information from various data servers across the network.

Servers

FIG. 3 shows a number of front ends, for example in workgroups 31, 32, and data servers, 36a-d, interacting through a network 34, such as the Internet. Human users access the system through a front end application that accesses one of many metaweb servers 33a, 33b on the network. These metaweb servers then access the registry through local caches, updated from one or more registry servers 38. The information in the registry is then used to identify data servers 36a-36d, which are accessed to obtain the data.

As shown in the figure, there are several types of servers provided in the backend system.

Metaweb Servers

Metaweb servers provide access to the system through APIs that may be used either by automated processes, or by front-end applications that are in turn used by humans. These servers access the contents of the registry and then obtain data from data servers to fulfill user requests.

Data Servers

A potentially very large number of data servers store the underlying data and metadata. The system supports implementations where this data is multiply redundant on several servers to ensure availability. Data servers operate independently and can be administered independently. They provide data access via standard protocols such as HTTPS, NFS, and SQL queries.

Registry Servers

The registry is stored in a number of registry servers, and is also cached by metaweb servers as required. Information about data, its components, associated metadata, and all related links is stored in a registry. As with the data servers, the registry may be distributed across a number of servers, for redundancy and for performance. Multiple registry servers can work together to form a distributed hierarchical cache of the directory, using a scheme similar to the Domain Name Server system of the Internet.

The registry servers may facilitate the maintenance of various different registries.

Pen name registry. An author must register content under a pen name, and this pen name must itself be registered with the registration server. A pen name may be a real name or an alias. Pen names are unique identifiers; the registration server does not register the same pen name to two different people. A pen name may be registered anonymously, that is without supplying a real name, in which case it is identified as such. A single author may have more than one pen name. Each pen name has an associated password, which is used to verify the identity of the author.

Content registry. The content registry keeps a record of all the content on the knowledge web, including explanations, paths, and annotations. The registry keeps track of where information is, the author's pen name, and when the information was registered. The content registry also keeps track of some specific attributes including the topics linked to explanations, the usage and voting statistics associated with content. When an author registers content, he must affirm that he either owns the content, or has the right to publish it in the knowledge web. If there are access restrictions on content, the registration can specify a permission server that is empowered to negotiate access. The content registry not only registers content but it also provides access to the registration information. All content registration information is publicly available. The content registry is not responsible for vetting the content that is registered; it only keeps track of its existence.

Topic registry. The topic registry keeps track of all topics, including TUKs. Unlike the content registry, the topic registry attempts to impose some order on the arrangement of topics, and for this reason it may be desirable to have multiple and competing topic registries. The central editorial problem of the topic registry is to keep the topic tree well organized and to keep the number of topics manageable. The topic registry registers any topic that meets certain minimal standards, but it may later decide to merge it with a similar topic. After such a merger, all links to either of the component topics are interpreted as linked to the merged topic.

Storage Domains

The system stores data and metadata in one or more storage domains connected to the system. These storage domains are typically disk based files systems representing a specific database. The system allows the data and metadata associated with an object to be stored as multiple components in multiple storage domains.

The system also allows data and metadata components to be stored redundantly, either within a single storage domain, or across multiple storage domains.

Access permissions are controlled by user and by storage domain. Each user has a set of access privileges associated with each storage domain. The system administrator of the storage controls which users are granted which privileges. Specific privileges may be granted to allow a uses read, add, modify, search, or delete data within that domain. A user may also have a privilege that allows a user to be aware that data exists with a storage domain, without necessarily being able to access that data.

Security

All user requests are subject to the user having the right authorization for the request. There are two places where this authorization is managed—the user's profile and the data server's rules. When the user logs on to the metaweb server, the user's profile is accessed, and security and data access authorization information that is specific to that user is retrieved. Subsequently, when the user makes a data request, the metaweb server uses the authorization information to process it. In addition, access rules are also defined at the data server to specify the kind of users that have access to read or update the data on that server.

Services and Applications Program Interfaces

Accessing Data

A user interacts with the system through a user interface application. A set of Applications Program Interfaces (APIs) describes protocols for accessing and modifying the database. Automated processes also interact with the system through this set of APIs. The actual preparation of such APIs is considered to be within the skill of those skilled in the art and, accordingly, they are not discussed in detail in this document.

The objects potentially accessible to users include data nodes, labeled links, and concept nodes. Which objects are actually accessible to a particular user depends upon the user access privileges to the storage domains that hold the data associated with the object.

When a user requests a node, the system fetches and assembles all data and metadata components associated with the node that are accessible to the user. This includes all objects linked from that node that are accessible to the user.

Adding Data Objects

The API allows authorized users to add data objects, concepts nodes and links to the system, specifying the storage locations of the related data and metadata.

Updating Objects

The API allows authorized users to update objects in the system by changing or adding metadata associated with that object. The data associated with a data node are not allowed to change. All updates to data create a new data object because the unique index is modified. The original data object is flagged as updated, with a link pointing to the new version.

Updates to certain objects triggers an administrative process to provide for archival and verification services.

The system provides metadata tags that are placed on objects, specifying those users that are to be notified whenever that object is updated. The system provides the notifications to users specified by those tags.

Deleting Objects

The API allows authorized users delete objects from the system by labeling them as deleted. The system allows the system administrator to establish policies for the actual deletion of objects that are so labeled.

Requesting Notification

Authorized users can request notification if a data object they are interested in is changed, deleted, or has metadata added to it. This is done by connecting a user change-notification link from the data object to the concept node representing the user.

Searching

The API allows search engines and automatic indexers to match objects with particular characteristics. These search engines are applications that use the system, but that are not built into the system architecture.

Authentication

The system provides a mechanism for notifying the user if the data associated with an accessed data node have changed since the object was created.

Access Hiding in the Metaweb Server

When accessing open-source material there is a potential security problem with repeated accesses to open data, in that the pattern of accesses from a single source may itself attract unwanted attention. The system supports two mechanisms for mitigating this problem.

The first mechanism is the data caching mechanism, which can prevent multiple remote accesses to the data. The system is capable of keeping a cached copy of all documents examined, so that they do not need to be retrieved a second time for reexamination. The second method for hiding patterns of access is indirection through an anonymous relay. The system allows multiple access to the same data server to be masked by indirectly accessing the site through anonymous relays. Such techniques as data caching and anonymous relays are well known in the art and are not discussed herein.

Administrative Functions

Users. The system allows the system administrator to add new users to the system. Users are represented as concept nodes within the system with associated metadata represented as labeled links. These metadata include information about user access privileges, and information (such as an email address) about how to send notification to that user. Normally this information is stored within a storage domain only accusable to a system administrator.

Storage Domains. The system allows the system administrator to add new storage domains to the system and to specify an administrator for such storage domains.

Data Formats. The system allows the system administrator to add new data types, link types, and data storage formats to the system.

Auditing Functions. The system architecture allows auditing functions to be provided within storage domains. The architecture allows, but does not include, auditing functions to monitor a user's or system administrator's patterns of activity within each within storage domain.

The Registry

Because the registry and the methods used to maintain the registry are a central feature of the invention, they are described in detail with reference to the presently preferred embodiment.

The registry is a distributed, hierarchical directory of information describing nodes and links of the labeled graph. The registry maintains information about the location of each data object's representation and the representation of its associated metadata. In other words, the registry makes the connection between the elements of the graph and the bits that represent them. The registry keeps track of where the data that represents each object are stored. The registry is stored on one or more registry servers and part of it can also be cached by one or more metaweb servers.

The Registry and Index Hash

When a data object is registered in the system, its type and content are used to generate a fast, unique hash value, which is used as the aforementioned index into the registry. This hash value is used to identify and register the data object into the registry and is used as the index in the registry's hash table. In the preferred embodiment, the index hash is chosen from a 128-bit address space, and is assumed to be unique for each object. If the same object is encountered twice, then both instances generate the same hash index. Thus, identical objects of identical types are always treated by the system as a single object.

Data Object Representation

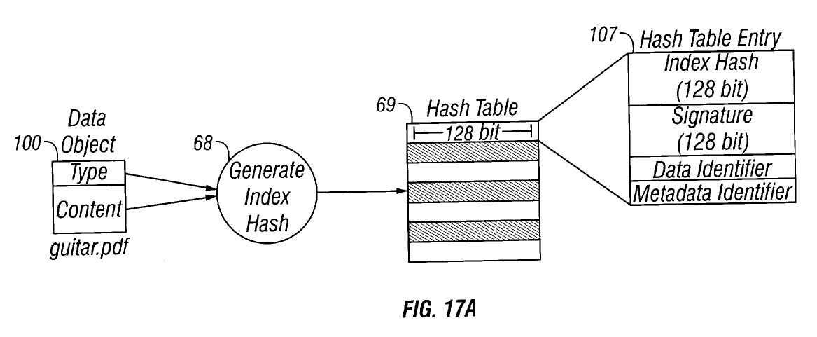

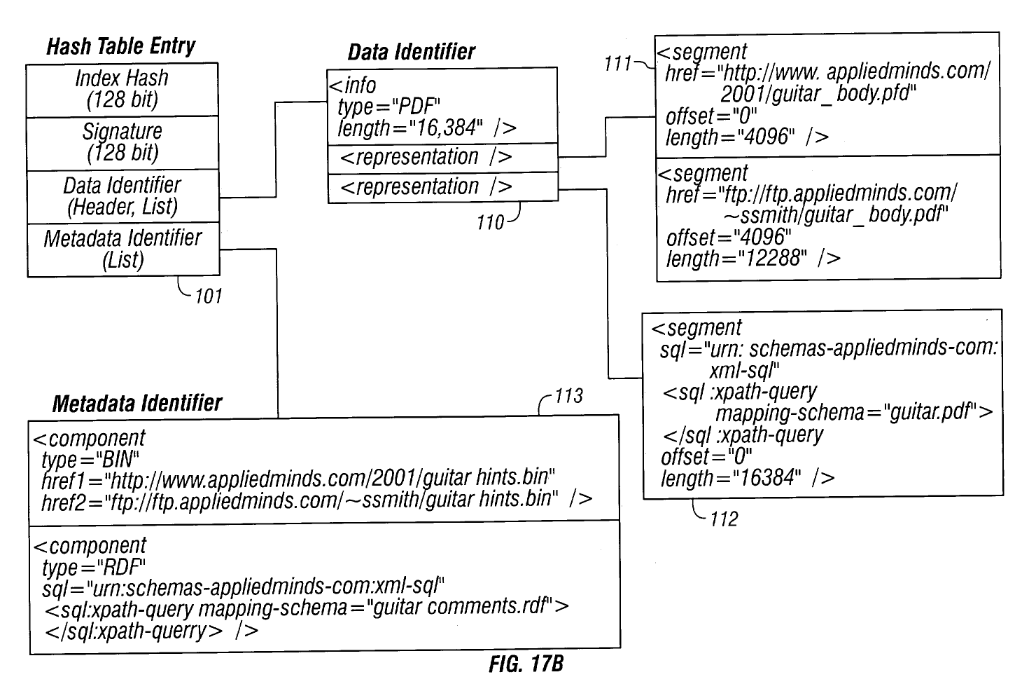

FIG. 17a is a block schematic diagram that shows the data object registry process. Each registered data object 100 is represented as a hash table 69 entry 101. Hash table entries identify a data object's location, representation, and any associated information annotating the data. Specifically, each hash table entry contains an index hash 68, an optional cryptographically strong signature for verification and security, a data identifier, and a metadata identifier.

FIG. 17b denotes the structure of a hash table entry 101. Along with the index hash and signature, a hash table entry contains a data identifier 110 describing the data object's type, length, and one or more representations of the object's data 111, 112. The hash table entry also contains a metadata identifier 113, which includes an indication of the annotations of the data object.

Index Hash

The index hash may be computed using a combination of one or more of the following methods.

Method P is padding algorithm applied to all data to ensure it is of sufficient length.

Methods H, I, and D may be applied to padded data, such as that generated by Method P, to generate the index hash used to identify a data object. Method H is a simple implementation, and Method I is an approach extended to take advantage of vector operations available on microprocessors. Method D employs a different approach capitalizing on the ability of a vector processor to perform dot products rapidly.

Method P (Padding data) Given a piece of data, pad it to a length which is a multiple of B words.

P1 [Initialize] Set I←(length of the data in bytes)

P2 [I mod B==0?] Set I←I mod B. Finish if I==0. If not, add some data.

P3 [Append number of remaining bytes] Append a byte containing the value I.

P4 [I==0?] Decrement I. Finish if we are there.

P5 [Append the data] Append bytes from the original data one at a time, decrementing I. If I reaches zero, finish. If we run out of bytes, loop to step P3.

Note that in step P5, the data may be appended from the beginning of the input stream, which requires that the first B−2 bytes of data be stored. Alternatively, the data can be appended from the beginning of the last block of data read in.

The following code implements the latter method.

class PaddedStream {
public:

PaddedStream(int pad);
˜PaddedStream();
void setStream(int fd);
int getChar(unsigned char *c);
int getInt(unsigned int *i);
int getLong(unsigned long *l);
int fillBufferFromFile();

private:

int getBuff(unsigned char *b, int n);
char *start;
int padlen;
int fd;
int outcount, buffercount;

};
PaddedStream::PaddedStream(int pad)
{

padlen=pad<<2;
buffercount=0;
outcount=0;
start=(char *)calloc(padlen, sizeof(char));

}
PaddedStream::˜PaddedStream()
{

free(start);

}
void
PaddedStream::setStream(int infd)
{

outcount=0;
fd=infd;
fillBufferFromFile();

}
int
PaddedStream::fillBufferFromFile()
{

int i, index;
index=buffercount=read(fd,start,padlen);
if(buffercount>0)

while(index<padlen) {

start[index]=(padlen−index) >> 2;
index++;
i=0;
while(i<buffercount) {

start[index++]=start]i++];
if(index==padlen) break;

}

}

return buffercount;

}
int
PaddedStream::getBuff(unsigned char *b, int n)
{

int i;
for(i=0;i<n;i++) {

if(outcount<padlen) {

b[i]=start[outcount++];

} else if(fillBufferFromFile()) {

outcount=0;
b[i]=start[outcount++];

} else break;

}
return i;

}
int
PaddedStream::getChar(unsigned char *c)
{

return getBuff((unsigned char *)c, sizeof(char));

}
int
PaddedStream::getInt(unsigned int *i)
{

return getBuff((unsigned char *)i, sizeof(int));

}
int
PaddedStream::getLong(unsigned long *l)
{

return getBuff((unsigned chat *)l, sizeof(long));

}

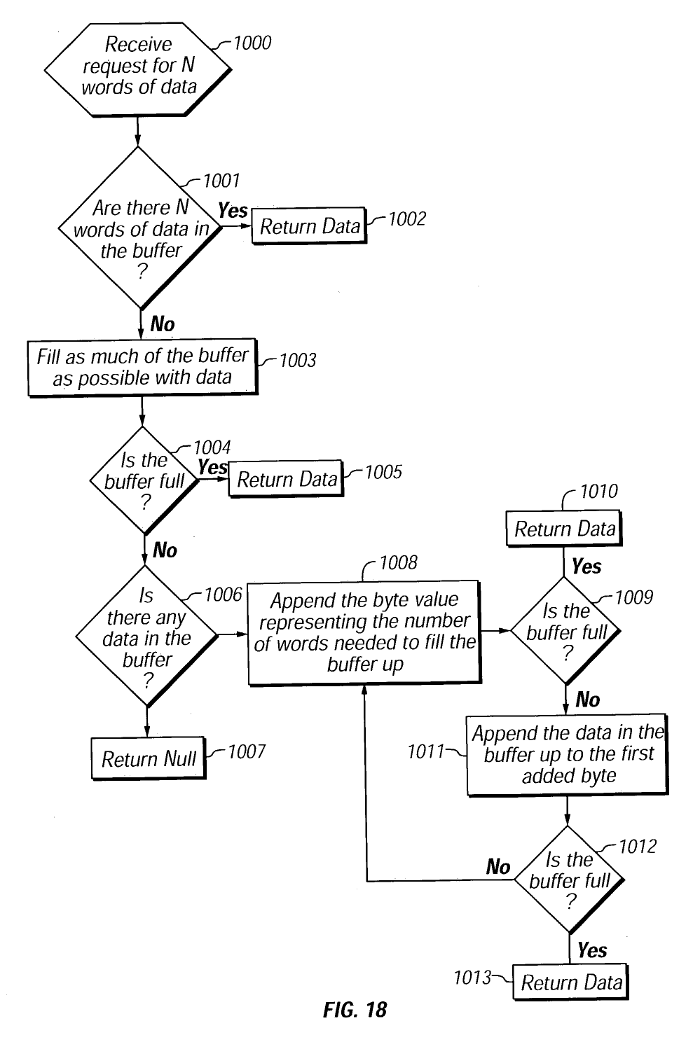

FIG. 18 shows a flow chart detailing the preferred implementation of Method P according to the invention. In this technique a request is received for N words of data (1000). A test is performed to determine if there are N words of data in the buffer (1001). If there are, the data are returned (1002). If not, the system fills as much of the buffer as possible with data (1003). Thereafter, a test is performed to determine if the buffer is full (1004). If it is, the data are returned (1005). If not, a test is performed to determine if there are any data in the buffer (1006). If not, a null value is returned (1007). If there are data in the buffer, the byte value representing the number of words needed to fill the buffer is appended (1008) and a test is performed to determine if the buffer is full (1009). If the buffer is full, the data are returned (1010). If not, the data in the buffer are appended up to the first added byte (1011). Thereafter, a test is performed to determine if the buffer is full (1012). If the buffer is full, the data are returned (1013). If the buffer is not full, the process again appends the byte value representing the number of words needed to fill up the buffer and continues (1008).

Method H (Generating the identity) Given a padded data stream as above, produce a 128-bit identity. The data are stored in a byte array M [1 . . . m ]. The array H [j] contains 32-bit values H [0 . . . n−1 ], where n≦16 and n has no factors in common with 33. The method uses one 64-bit register rA and one 128-bit register rB which contains the final value. Initially rB is set to a non-zero value H₀. H₀ may be, for example, the first 128 binary digits of π. rB is accessible as four 32-bit registers rB[[0 . . . 3]]. rA is accessible as two 32-bit registers rA[[0 . . . 1]].

H1 [initialize] Set i←1,j←0,rB←H₀.

H2 [collect] Set rA[[0]]←M[i . . . i+3]. Set rA[[1]]←0. Set i←i+4.

H3 [multiply] Set rA←rA×H[j]mod 2⁶⁴. Set j←(j+1) mod n.

H4 [middle] Set rA←(rA>>16)&0×00000000FFFFFFFF.

H5 [multiply in] Set rA←(rA×rB[[3]])mod 2⁶⁴.

H6 [middle] Set rA←(rA>>16)&0×00000000FFFFFFFF.

H7 [subtract] Set rB[[2]]←(rA−rB[[2]])mod 2³².

H8 [rotate] Rotate rB left by 33 bits.

H9 [loop] If i<m, loop to step H2. Otherwise, finish, rB contains the identity.

Method I (Generating the identity, parallel Given a padded data stream, produce a 128-bit identity. The data are stored in a byte (8-bit chunks) array M[1 . . . m]. The array H[j]contains 32-bit values H[0 . . . n−1],where n≦16 and n has no factors in common with 33. The method uses two 128-bit registers rA and rB. rB contains the final value. Initially, rB is set to a non-zero value H₀. H₀ may be, for example, the first 128 binary digits of π. Both registers are accessible as four 32-bit registers rX[[0 . . . 3]]or as two 64-bit registers rX[0 . . . 1].

I1 [initialize] Set i←1,j←0.

I2 [collect] Set rA[[0]]←M[i . . . i+3] and rA[[2]]←M[i+4 . . . i+7]. Set rA[[1]]←0 and rA[[3]]←0. Set i←i+8.

I3 [multiply] Set rA[1]←rA[1]×H[j]mod 64 and rA[0]←rA[0]×H[(j+1)mod n]mod 2⁶⁴. Set j←(j+1)mod n.

I4 [middle] Set rA←(rA 16)&0×00000000FFFFFFFF00000000FFFFFFFF.

I5 [multiply in] Set rA[1]←(rA[1]×rB[[3]])mod 2⁶⁴ and rA[0]←(rA[0]×rB[[1]])mod 2⁶⁴.

I6 [middle] Set rA←(rA>>16)&0×00000000FFFFFFFF00000000FFFFFFFF.

I7 [subtract] Set rB[[2]]←(rA[[2]]−rB[[2]])mod 32 and rB[[0]]←(rA[[0]]−rB[[0]])mod 2³².

I8 [rotate] Rotate rB left by 33 bits.

I9 [loop] If i<m, loop to step I2. Otherwise, finish, rB contains the identity.

The values H are selected to have the following properties:

1.Maximal average pairwise Hamming distance.

2.Equal number of 1 and 0 bits.

For example, the set

$$H = [ \begin{matrix}1 & 1 & 0 & 0 & 1 & 1 & 0 & 0 & 1 & 1 & 0 & 0 & 1 & 1 & 0 & 0 & 1 & 0 & 1 & 0 & 1 & 0 & 1 & 0 & 1 & 0 & 1 & 0 & 1 & 0 & 1 & 0 \\ 1 & 1 & 0 & 0 & 0 & 0 & 1 & 1 & 1 & 1 & 0 & 0 & 0 & 0 & 1 & 1 & 1 & 0 & 0 & 1 & 1 & 0 & 0 & 1 & 1 & 0 & 0 & 1 & 1 & 0 & 0 & 1 \\ 0 & 0 & 1 & 1 & 1 & 1 & 0 & 0 & 0 & 0 & 1 & 1 & 1 & 1 & 0 & 0 & 0 & 1 & 1 & 0 & 0 & 1 & 1 & 0 & 0 & 1 & 1 & 0 & 0 & 1 & 1 & 0 \\ 0 & 0 & 1 & 1 & 0 & 0 & 1 & 1 & 0 & 0 & 1 & 1 & 0 & 0 & 1 & 1 & 0 & 1 & 0 & 1 & 0 & 1 & 0 & 1 & 0 & 1 & 0 & 1 & 0 & 1 & 0 & 1 \\ 1 & 0 & 1 & 0 & 1 & 0 & 1 & 0 & 1 & 0 & 1 & 0 & 1 & 0 & 1 & 0 & 0 & 0 & 0 & 0 & 0 & 0 & 0 & 0 & 1 & 1 & 1 & 1 & 1 & 1 & 1 & 1 \\ 1 & 0 & 1 & 0 & 0 & 1 & 0 & 1 & 1 & 0 & 1 & 0 & 0 & 1 & 0 & 1 & 0 & 0 & 1 & 1 & 0 & 0 & 1 & 1 & 1 & 1 & 0 & 0 & 1 & 1 & 0 & 0 \\ 0 & 1 & 0 & 1 & 1 & 0 & 1 & 0 & 0 & 1 & 0 & 1 & 1 & 0 & 1 & 0 & 1 & 1 & 0 & 0 & 1 & 1 & 0 & 0 & 0 & 0 & 1 & 1 & 0 & 0 & 1 & 1 \\ 0 & 1 & 0 & 1 & 0 & 1 & 0 & 1 & 0 & 1 & 0 & 1 & 0 & 1 & 0 & 1 & 1 & 1 & 1 & 1 & 1 & 1 & 1 & 1 & 0 & 0 & 0 & 0 & 0 & 0 & 0 & 0 \\ 1 & 1 & 0 & 0 & 1 & 1 & 0 & 0 & 0 & 0 & 1 & 1 & 0 & 0 & 1 & 1 & 1 & 0 & 1 & 0 & 0 & 1 & 0 & 1 & 1 & 0 & 1 & 0 & 0 & 1 & 0 & 1 \\ 1 & 1 & 0 & 0 & 0 & 0 & 1 & 1 & 0 & 0 & 1 & 1 & 1 & 1 & 0 & 0 & 1 & 0 & 0 & 1 & 0 & 1 & 1 & 0 & 1 & 0 & 0 & 1 & 0 & 1 & 1 & 0 \\ 0 & 0 & 1 & 1 & 1 & 1 & 0 & 0 & 1 & 1 & 0 & 0 & 0 & 0 & 1 & 1 & 0 & 1 & 1 & 0 & 1 & 0 & 0 & 1 & 0 & 1 & 1 & 0 & 1 & 0 & 0 & 1 \\ 0 & 0 & 1 & 1 & 0 & 0 & 1 & 1 & 1 & 1 & 0 & 0 & 1 & 1 & 0 & 0 & 0 & 1 & 0 & 1 & 1 & 0 & 1 & 0 & 0 & 1 & 0 & 1 & 1 & 0 & 1 & 0 \\ 1 & 0 & 1 & 0 & 1 & 0 & 1 & 0 & 0 & 1 & 0 & 1 & 0 & 1 & 0 & 1 & 0 & 0 & 0 & 0 & 1 & 1 & 1 & 1 & 1 & 1 & 1 & 1 & 0 & 0 & 0 & 0 \\ 1 & 0 & 1 & 0 & 0 & 1 & 0 & 1 & 0 & 1 & 0 & 1 & 1 & 0 & 1 & 0 & 0 & 0 & 1 & 1 & 1 & 1 & 0 & 0 & 1 & 1 & 0 & 0 & 0 & 0 & 1 & 1 \\ 0 & 1 & 0 & 1 & 1 & 0 & 1 & 0 & 1 & 0 & 1 & 0 & 0 & 1 & 0 & 1 & 1 & 1 & 0 & 0 & 0 & 0 & 1 & 1 & 0 & 0 & 1 & 1 & 1 & 1 & 0 & 0 \\ 0 & 1 & 0 & 1 & 0 & 1 & 0 & 1 & 1 & 0 & 1 & 0 & 1 & 0 & 1 & 0 & 1 & 1 & 1 & 1 & 0 & 0 & 0 & 0 & 0 & 0 & 0 & 0 & 1 & 1 & 1 & 1\end{matrix} ]$$

may be used. This set has no pair of bit vectors with more than eight bits in common. Note that any permutation of rows or columns of this set also satisfies the requirements. It is also possible to permute the rows or columns independently of the first and last 16 bits.

Method D takes advantage of vector processor capabilities using long dot products. The data are assumed to be padded to a multiple of n (size of H) 32 bit values, as, for example, provided by Method P. The algorithms may be adjusted to accommodate a matrix H of different dimension.

Method D (Generating the identity, dot products) Given a padded data stream, produce a 128-bit identity. The data are stored in a byte array M[1 . . . m]. An array H[j] as above is again used, with the additional restriction that n be even. The method uses three 128-bit registers rA, rB, and rC. rC contains the final value. All registers are accessible as four 32-bit registers rX[[0 . . . 3]] or as two 4-bit registers rX[0 . . . 1].

D1 [initialize] Set i←1, j←0, rB←0.

D2 [collect] Set rA[[0]]←M[i . . . i+3] and rA[[2]]←M[i+4 . . . i+7]. Set rA[[1]]←0 and rA[[3]]←0. Set i←i+8.

D3 [multiply] Set rA[1]←rA[1]×H[j]mod 2⁶⁴ and rA[0]←rA[0]·H[(j+1)]mod 2⁶⁴. Set j←(j+2).

D4 [dot sum] Set rB[0]←(rB[0]+rA[0])mod 2⁶⁴ and rB[1]←(rB[1]+rA[1]) mod 2⁶⁴.

D5 [dot loop] Set j←j+2. If j<n−1, loop to step D2. Otherwise, set j←0 and continue.

D6 [dot shift] Set rB←rB>>16, shifting in zeros.

D7 [add in] Set rC←rC+rB

D8 [rotate] Rotate rC right 33 bits.

D9 [loop] If i<m, loop to step D2. Otherwise, finish, rC contains the identity.

The following code may be used to implement Method D. The code is written as a 256 bit implementation. However, it may be trivially modified to achieve the 128 bit implementation described in Method D, or implementations based on other word sizes. This implementation uses the PaddedStream class defined in the Method P code above.

void dotprodident(int intstream, int *id)
{

PaddedStream P(128);
unsigned long long accum, outll, outlh, outhl,

outhh;

unsigned long long ilowlow, ilowhi, ihilow, ihihi;
unsigned int a, b, i;
P.setStream(intstream);
accum=0;
ilowlow=0;
ilowhi=0;
ihilow=0;
ihihi=0;

//assumes that padded length is a multiple of 64
ints

while(P.getInt(&a)>0){

P.getInt(&b);
//build up the dot product of 16 values mod

2\hat{ }64

for(i=0;i<14;i+=2){

accum+=(unsigned long long)H[i]*(unsigned

long long)a;

accum+=(unsigned long

long)H[i+1]*unsigned long long)b;

P.getInt(&a);
P.getInt(&b);

}
accum+=(unsigned long long)H[i]*(unsigned long

long)a;

accum+=(unsigned long long)H[i+1]*(unsigned

long long)b;

//shift the dot product over and add it to the

identity mod 2\hat{ }128

accum = accum >> 16;
ilowlow+=accum;
//in assembly this is just a jump on overflow
if(ilowlow<accum){

ilowhi++;

ihilow++;
if(ihilow<1){

ihihi++;

}

}

{
//33 bit roll
outll=(ilowlow&0x1FFFFFFFF11) << 31;
outlh=(ilowhi&0x1FFFFFFFF11) << 31;
outhl=(ihilow&0x1FFFFFFFF11) << 31;
outhh=(ihihi&0x1FFFFFFFF11) << 31;
ilowlow=(ilowlow >> 33) | outlh;
ilowhi=(ilowhi >> 33) | outhl;
ihilow=(ihilow >> 33) | outhh;
ihihi=(ihihi >> 33) | outll;

}
id[0]=(ihihi&0xFFFFFFFF0000000011)>>32;
id[1]=(ihihi&0xFFFFFFFF);
id[2]=(ihilow&0xFFFFFFFF0000000011)>>32;
id[3]=(ihilow&0xFFFFFFFF);
id[4]=(ilowhi&0xFFFFFFFF0000000011)>>32;
id[5]=(ilowhi&0xFFFFFFFF);
id[6]=(ilowlow&0xFFFFFFFF0000000011)>>32;
id[7]=(ilowlow&0xFFFFFFFF);

}

Signature

Like the index hash, the signature of the data object is computed using the data object type and content. However, the signature is computed using a cryptographically strong technique.

Data Identifier

A data identifier contains a data object's type, length, and representation. Typically, data objects only have one representation, but data objects may have multiple alternate representations, for reason of redundancy, efficiency, or administrative convenience. These multiple representations may be stored in different places or even different formats, but they must describe exactly the same object.

A data object's representation may contain one or more segments. Typically, data objects only have one segment, but it is possible to spread the representation of an object across multiple segments. For each segment, the data identifier contains information denoting how to find a string of bits that represent a part of the data object. For example, a segment may be specified by a path to a file and an offset and length of the string of bits representing the segment within the file. Alternatively, the segment may be specified by a query made to a database.

The data object is constructed by obtaining the bits associated with each segment, concatenating them together sequentially, and interpreting them as specified by the type. Once all of the bits are collected, they may then be verified by comparing the index hash computed from the concatenated data and the type with the index hash stored in the hash table. In some circumstances, the constructed object may also be verified by checking the cryptographically strong signature of the object, again computed from the data and the type. All segments of the data object of at least one type must be accessible for the object to be accessible.

Metadata Identifier

A metadata identifier contains one or more components that indicate the type and location of one or more links annotating the data object. Each metadata component can specify multiple alternative locations where the metadata can be found. Each location has a type specifying the format of the metadata stored in that location. For example, the same metadata may be stored in human readable text format in one location, and in a compiled binary format in another location.

The metadata for an object are constructed by obtaining the data from one location indicated by each component. The metadata are then collected and interpreted based on each location's type. It is not necessary that all components be accessible. Inaccessible components are ignored, so a user only sees the metadata associated with accessible components.

The metadata identifier may be implemented using a fixed length handle, preferably of 128 to 196 bits, that can be interpreted either as a first-class-object “pointer,” or as a literal. At least one of the bits has to be used to distinguish which type it is. Literals are object that are small enough to store the data in the handle.

handle=index-hash|literal-representation

If the handle is an index=hash, it is generated from the hash code of the data/type pair. It the handle is a literal, some of the bits are used to say what type it is.

literal-representation=literal-type literal-data

literal=literal-type literal-data

literal-type=fixnum|float|short-string|global-symbol|time|location|character| . . .

The fixnum is a 64+ bit signed integer. The float is an IEEE floating point number. Short-string is any string of up to N ASCII characters. Links can then be represented by triples of handles. Typically, the label of a link is a global symbol, but it could also be another object.

link=from-connection to-connection label-connection

from-connection=handle

to-connection=handle

label-connection=handle

First class objects are the only kind of objects that can have metadata attached to them. A first-class object can be a literal, but most literals are not first-class objects. A first-class object can also be a link, but most links are not first-class objects.

object=first-class-object|literal

first-class-object=small-first-class-object|large-first-class-object

small-first-class-object=small-literal metadata-locator

large-first-class-object=handle object-type data-locator signature metadata-locator

large-object-type=data-type|big-literal-type

object-type=Link|Binary|Text|JPEG|Postscript|RTF|Wave| . . .

Large first-class objects, that is all first-class objects except literals, have a list of references to external places where segments of their data is stored. Most object have just one segment, but when there are more than one, the data is assembled by concatenating these segments together.

data-locator={data-component-locator}

Each segment can have pointer to an alternate component for the same data. The different metaweb servers may have the alternatives in a different order for performance reasons.

data-segment-locator=resource-locator [alternate-data-segment-locator]

alternate-data-segment-locator=data-segment-locator

All first-class objects have a list of references to external places where components of their metadata, are stored. The data are assembled by combining the metadata from these components.

metadata-locator={metadata-component-locator}

Each component can have pointer to an alternate component for the same metadata. Again, the different metaweb servers may have the alternatives in a different order for performance reasons. Each alternative indicates the format of that alternatives representation of the component.

data-component-locator=metadata-data-format resource-locator [alternate-metadata-component-locator]

alternate-metadata-component-locator=metadata-component-locator metadata-data-format=RDF|Complied| . . .

A resource location is a URL. It may be a pointer to a file, or a database query. It specifies where and how the data is to be found.

resource-locator=protocol domain specification-string

Descriptive Scenarios

The structure of the system described in the previous sections lends itself to a great variety of system features and functions. An illustration of some of these features and functions is provided in the following scenarios.

Search/Query

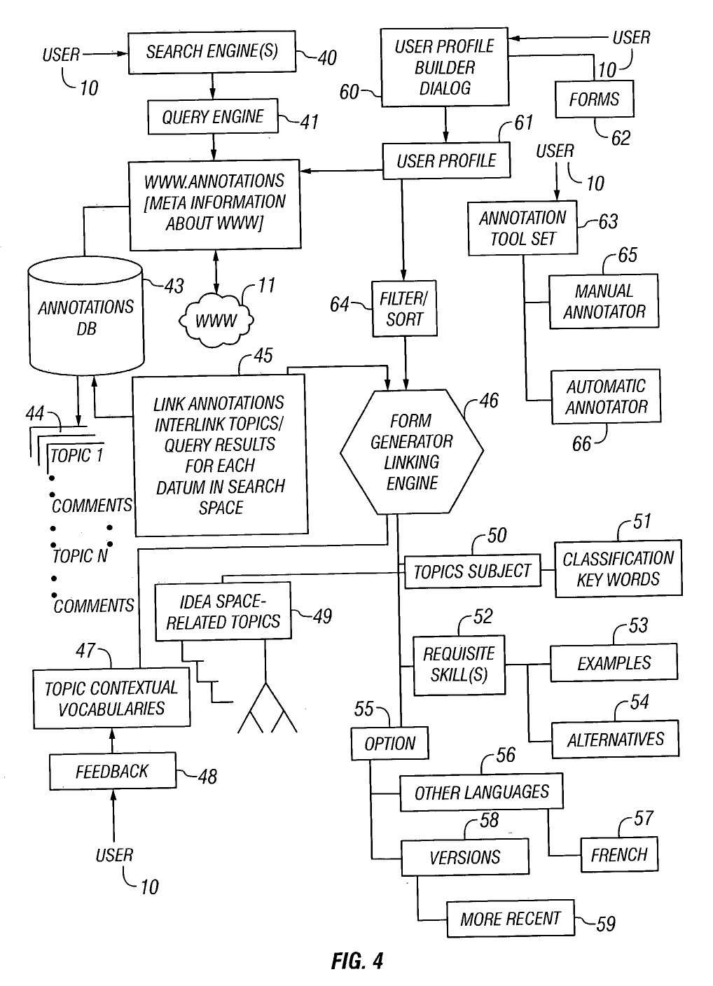

In FIG. 4, a user 10 initiates a query using any of several search engines 40, which drive a query engine 41. The query engine accesses meta-knowledge 42 about the universe of knowledge, which in this case is the World Wide Web 11. The meta-knowledge, or user annotations and document metadata regarding the content in the universe of knowledge, are stored in an annotations database 43 which resides on one of the content servers. The annotations are themselves content, and may in turn be linked to other content and topics in the search space 45.

User Profile

A user of the knowledge web may have a user profile, created, for example, using a user profile builder dialog 60 that uses various forms 62 to build a user profile 61. The user profile works in connection with the meta-knowledge to filter the knowledge, so that the user gets the information they want when they want it. The user profile is also used as a filter/sort mechanism 64 in connection with a result-set processing system 46 that allows the user to add annotations and link topics to the knowledge.

Result-Set Processing System

The result-set processing system 46 also interacts with the user when a user provides feedback 48 on topics and contextual vocabularies 47. The feedback is applied in connection with the results provided to the user, and it is also used to build up the annotations database.

The result-set processing system 46 provides features to manage the idea space of the knowledge and related topics 49. There is a topic subject 50 based upon classification and keywords 51. There is also provision for determining requisite skills 52 with regard to the information produced by the query on the knowledge web which is supported by examples 53 and alternatives 54. Finally, there are a series of options provided 55, which may include for example other language versions 56 of the information, e.g. French 57, and other versions of the information 58, for example more recent versions 59, although in some cases, the user may desire to review an earlier version of the information.

Annotations

The user also interacts with an annotations tool set 63 which provides a manual annotator 65 that allows annotation by the user or by the proprietor of the information. As well, the system provides an automatic annotator 66.

Registration of Content

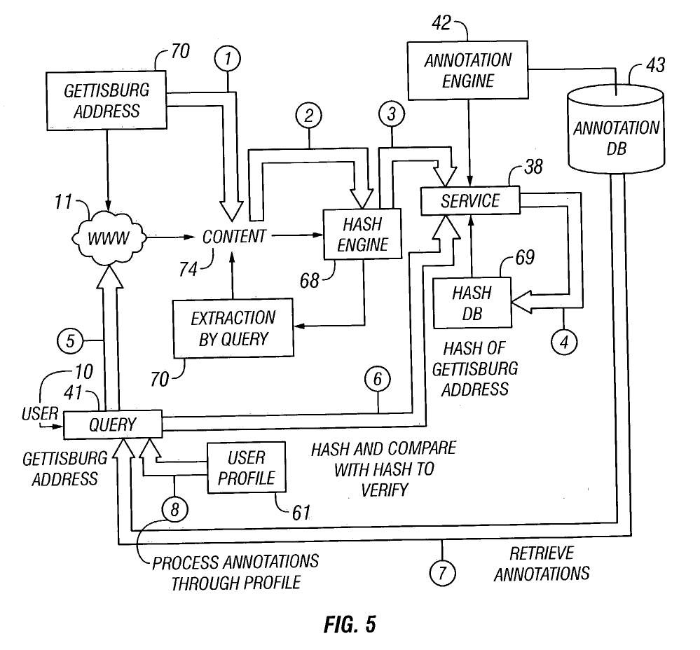

In FIG. 5 a piece of content, such as the Gettysburg Address 70, is registered within the knowledge web and also exists in universe of available knowledge, i.e. the World Wide Web 11. In this particular scenario, the content is extracted from the web by a query 70 (numeric designator 1). The content is provided to a hash engine 68 (numeric designator 2) to create an index hash. The hashed version of the content is provided to a registry server 38, (numeric designator 3) and is stored in a registry database 69, (numeric designator 4). The registry server operates in conjunction with the annotation server 42 which accesses the annotation database 43 to add any user annotations provided at this time as well as billing activities if applicable.

Annotation System and Process

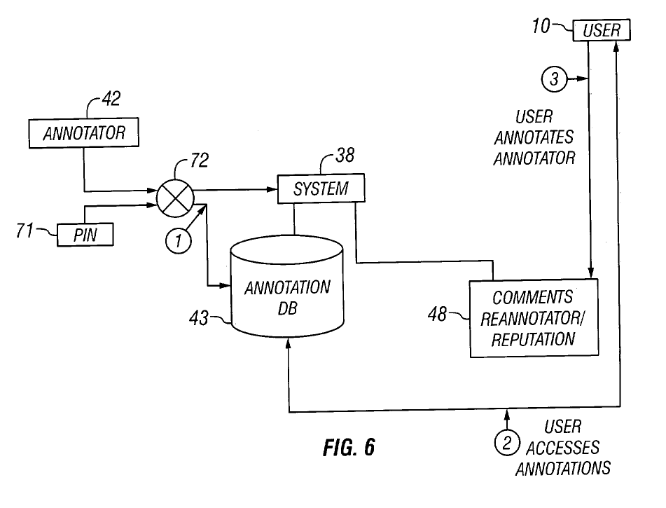

In FIG. 6, the annotation system is shown in greater detail. The annotation engine 42 operates to provide annotations to the annotation database 43 once the user has been verified. Such verification may be performed by any means, but in the exemplary embodiment of the invention, is provided when the user introduces a personal identification number (PIN) 71. A security technique 72 is applied that allows the annotator to access the annotation database for reading and or writing as appropriate (numeric designator 1). The user 10 thereafter accesses the annotations, as in indicated in FIG. 6 (numeric designator 2). Thereafter, the user can annotate the annotations, for example to provide feedback 48 in the form of comments, reviews, ratings, and the like, (numeric designator 3).

Display of Content and Annotations

When a user 10 uses the search engine 40 to posit a query, for example, “Tell me about the Gettysburg Address,” the query engine 41 in this example accesses both the universe of available information (numeric designator 5), and the metaweb server 38 (numeric designator 6). This results in the retrieval of knowledge from the universe of knowledge resulting from the user's query. Using the knowledge retrieved, an index hash is created, which is used to access the registry entry for that piece of knowledge in the registry database 69. Thereafter, user annotations and document metadata relating to the knowledge may be retrieved from the annotations database 43, (numeric designator 7). Finally, a user profile 61 may be applied to process the annotations through the user profile so that the user receives only those annotations of interest (numeric designator 8).

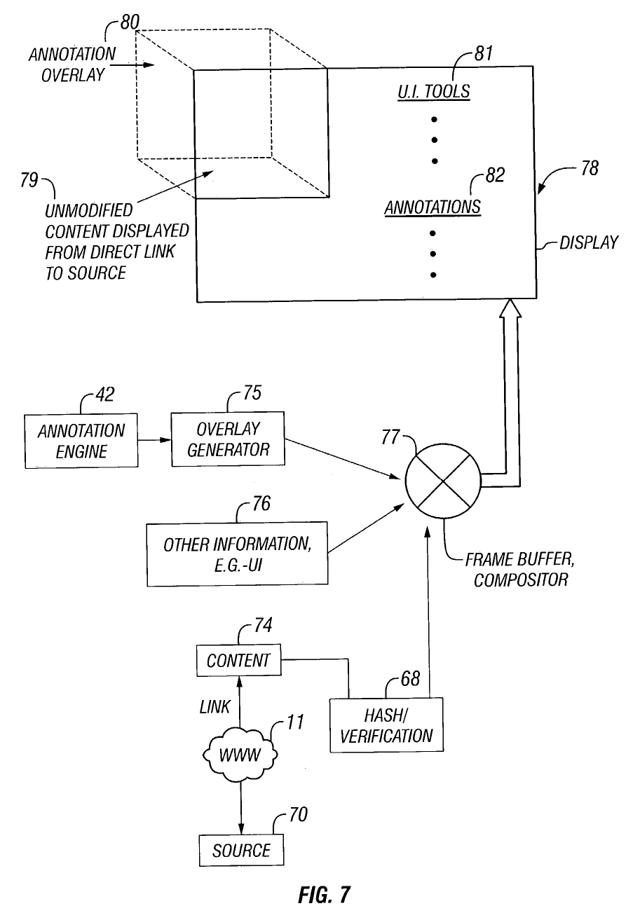

FIG. 7 provides a schematic diagram showing the annotation process and compositing of information for display to a user. In FIG. 7, the universe of available information 11, i.e. the World Wide Web, is used to access a source document 70, i.e. the Gettysburg address. The content is retrieved in this example by following a link as is known in the art. Thereafter, the content 74 is subjected to a hash procedure 68 as described above. The content information is thereafter provided to a frame buffer or compositor 77. Such techniques as frame buffering and compositing are well known in the art and are not discussed herein. Additionally, the annotation engine 42 operates in conjunction with an overlay generator 75 to provide the annotations to the display. Finally, any other information, such as user interface features 76 are provided to the frame buffer or compositor 77.

The result is a displayed image 78, which includes annotations 82, user interface features and tools 81, and the unmodified content from the source 79. The annotation overlay 80 is also provided. This aspect of the invention concerns the provision of content, for example copyrighted material, without modifying or in any way altering or copying the material. Rather, the knowledge web follows the link to the source information and merely displays the information on the display 78. The annotation overlay 80 superimposes the annotations onto or alongside the unmodified content. In this way, the invention allows the use of content annotations without copying the content to any persistent cache or storage medium. This obviates the likelihood that copyrights are violated.

Payments/Micropayments

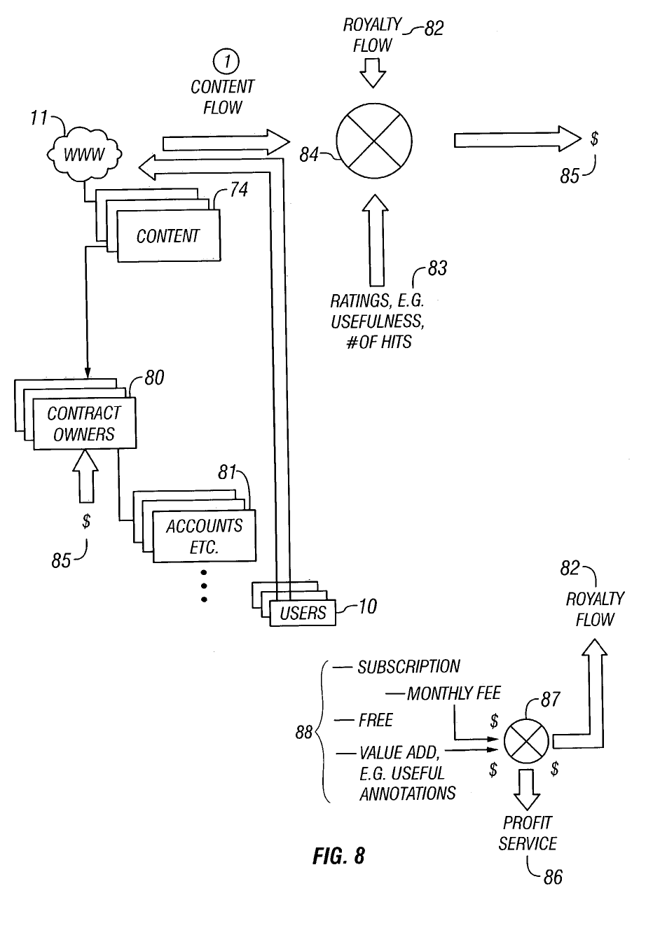

FIG. 8 illustrates a compensation scheme by which content 74 accessed from the universe of knowledge 11, i.e. the World Wide Web, allows content owners 80 to receive compensation 85 which may be maintained in an account 81 or otherwise provided to the content owner. In this aspect of the invention, a content flow is generated through the knowledge web (numeric designator 1). This content flow is provided to an accounting system 84 in which the access by users to content through the knowledge web is combined with ratings information 83 provided by the users through specialized user annotations, for example the usefulness of the information and/or a number of times the content has been accessed. As a result, fees paid by users 82, as discussed in more detail below, are apportioned to the content owners 80 to produce a compensation flow 85 based on such access and usefulness.

The users 10 are provided with various access plans 88, such as a subscription, for example based on a monthly fee; free access; or a value added access, for example where users pay to view annotations that are considered to be useful. A user accounting system 87 produces a royalty flow 82 which is then used to determine compensation to content owners 80. The user accounting engine also extracts revenue for the knowledge web in the form of profits from the service 86.

Personalized Knowledge Retrieval with User Profiles

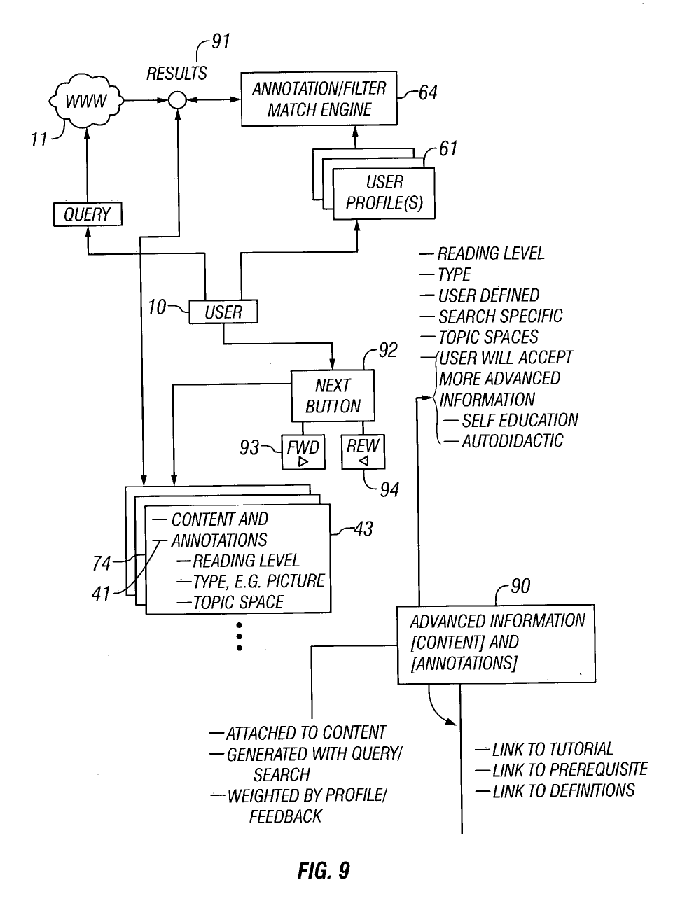

FIG. 9 illustrates a query session in which a user 10 posits a query through the query engine 41 to the universe of available knowledge 11, i.e. the World Wide Web. This generates various results 91 in the form of content 74 and annotations 43. The content and annotations may be provided in various ways, for example based upon the users reading level, the type of information preferred, e.g. a picture, the topic space (as discussed below). The results are produced both from the content source and by applying the user profile 61 to an annotation and filter engine performing matches 64. In this way, the annotations are matched to the user's reading level, preference types, and topics as mentioned above. The user profile is built with various types of information about the user and in this example is generated through the use of a form 62 as discussed above. The user profile includes such information as reading level, type or information preferred, user defined spaces, specific information preferred, topic spaces requested, and statements that the user accepts more advanced information in certain topics, for example auto-didacticism. Further, the profile may include an advanced information space 90 in which the content in annotations are provided in this particular way. For example, the annotations may link the content to a tutorial to explain the content to the user, there may be links to pre-requisites before the content is readily understood, so that the user is properly prepared for reviewing the contents, or there may be links to definitions. Further, the annotation may be attached to additional content which provides context for the content being reviewed. This additional information may be generated as part of the query and search 'posited by the user, and the information may be provided based upon a weighting based upon the user profile and feedback provided by the user, as well as feedback provided by other users.

Other User Interface Elements As the user peruses the results 91, the user may operate a “next” button 92. The “next” button is an important learning feature provided by the invention in which a forward indication 93 indicates to the knowledge web that the user is finding the information and the current path of the knowledge useful. In this case, the knowledge web proceeds along the path it is predicting as being useful to the user. There is also a “reverse” button 94. By selecting the “reverse” button, in this example, the user provides feedback that the path is not helpful and the knowledge web reformulates the basis for providing information. User operation of the forward and reverse buttons is used to build up the profile of the user, and also may be used to build further annotations and feedback based on the usefulness of information.

Graphical User Interface—Visualization

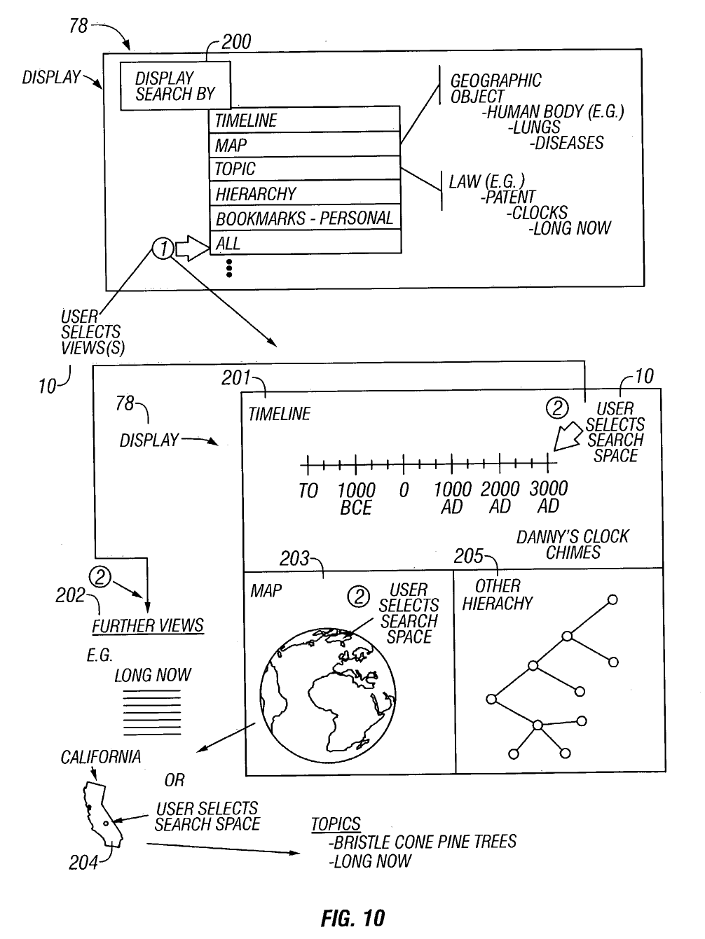

FIG. 10 is a schematic representation of various visualization aspects of the knowledge web. In FIG. 10, a display is shown in which a dialog box 200 provides a user 10 with various ways in which a search may be visualized. For example, the visualization may occur as a timeline; as a map (for example geographic map with regard to countries, or geological features, or an object map, for example with regard to the human body, where the map might point out the human beings lungs in connection with various human diseases); as a topic map (for example the topic of the law with regard to patents, and in particular clocks, specifically with regard to clocks made by the Long Now Foundation); as a hierarchical display; as a display of personal bookmarks, or as a combination of several or all of these forms of visualization. These particular views are provided by means of example and those skilled in the art will appreciate that other visualizations and views may also be provided.

After the user has selected a view, a display is presented to the user, as shown on FIG. 10 (numeric designator 1). The user may then select a search space, as shown on FIG. 10 (numeric designator 2). The search space could be for example based on a time line 201, for example where the Long Now Foundation's clock is shown to operate along a timeline relative to the number of years between clock chimes. The user may also select further views 202, as shown on FIG. 10 (numeric designator 3). For example, the user may choose a map view 203 that shows geographically where the Long Now clock is located. This view may be further enhanced by the user's selection of the map to produce an exploded view that shows more precisely or with better resolution the location of the desired item 204. When the user selects this particular search space, the knowledge web presents additional information about this geographical location. For example, the particular part of California where the Long Now Foundation is located is also known for bristle cone pine trees. Thus, when a user selects this particular geographical location, related topics, such as bristle cone pine trees, are offered to the user. Finally, the user may choose to view the search results in another form, such as a hierarchy 205.

Security

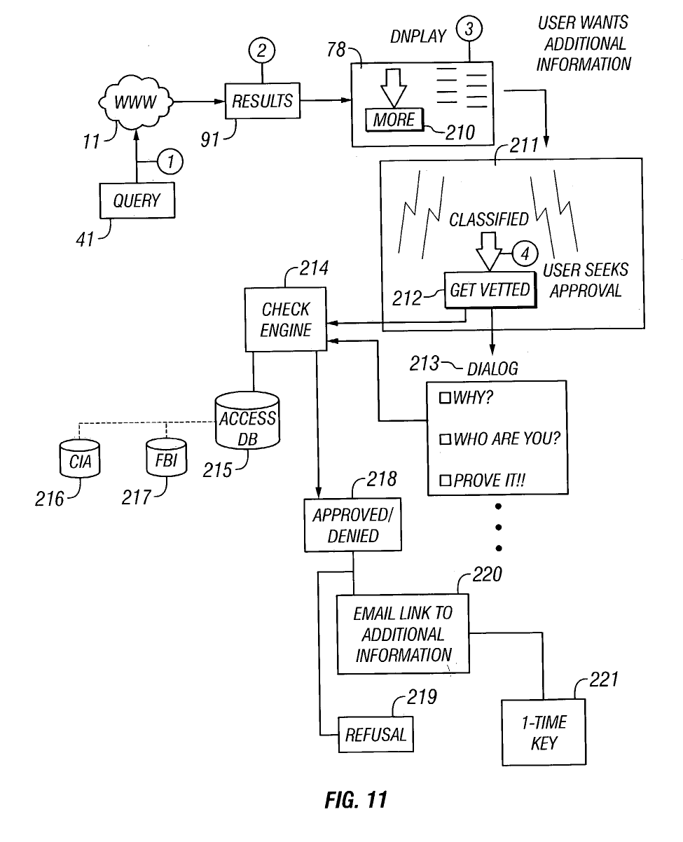

FIG. 11 shows one security aspect of the invention. When a query is presented to the universe of knowledge 11 by the query engine 41, those results are produced 91 as discussed above. This is indicated on FIG. 11 by the numeric designators (1) and (2). There is a space of information that is presented to the user on the display 78. If the user desires to view more, then a “more” feature 210 is selected by the user, as indicated on FIG. 11 by the numeric designator (3). The display then indicates, in this example, that the information is classified and requires a certain level of security clearance. In such cases, the user is provided with an opportunity to vet themselves to the system 212, for example by selecting a “get vetted” button as indicated on FIG. 11 by the numeric designator (4). In the presently preferred embodiment of the invention, a dialog 213 is presented which asks the user such questions as “Why is the information wanted?”, “Who is doing the asking?”, and “Provide proof.” The user answers are sent through a checking engine which compares the user information against an access database 215 to determine the users levels of authorization with regard to the information desired. The access database may include additional databases which are independently checked, such as a CIA database or an FBI database. The check engine then provides a response to the user 218, approving or denying access. If the request is denied, then the refusal is indicated to the user, either directly on the display 78 or via a return message, such as an email message. If approval is granted, then an authorization mechanism is invoked. In the presently preferred embodiment of the invention, an email link is provided to the user. When the user opens the email and clicks on the link contained therein, a one-time key 221 is provided that allows the user to have one-time access to the classified information.

User Operations Using the Result Set Processing System

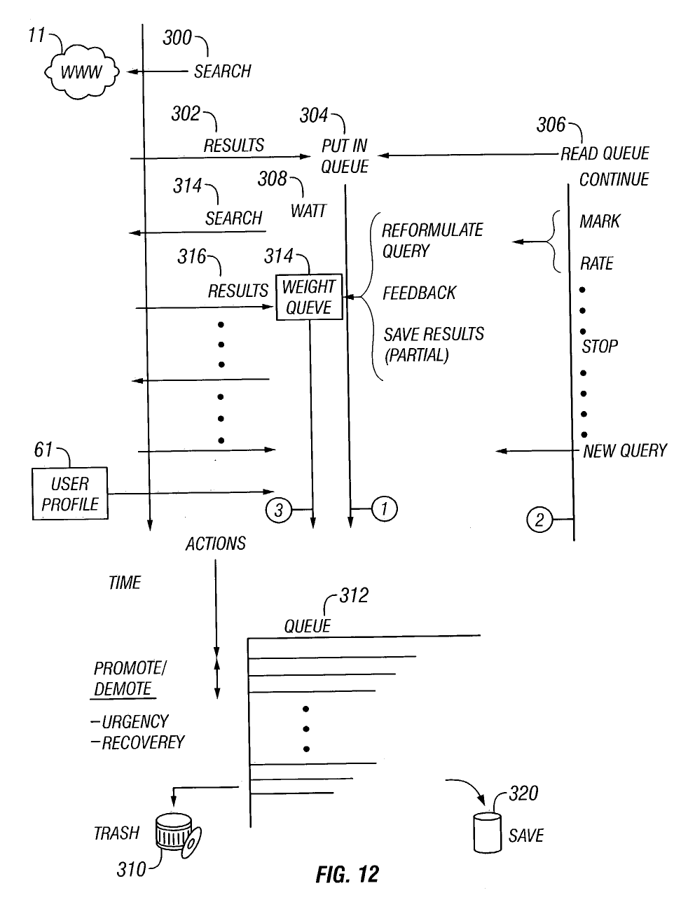

FIG. 12 is a flow diagram showing the operation of the knowledge web in connection with the result-set processing system. When a search is commenced 300, access is made to the universe of available information 11 and results 302 are provided through the result-set processing system 304 which provides them to the user. One of the functions of the result-set processing system 312 is to allow the user to promote and demote information in terms of urgency and relevancy. Thus, when results 302—including search results, user-created documents, email messages, and other forms of knowledge—being placed in the result-set processing system 304, the movement of the information is affected by various factors which are discussed below. Such movement is shown in the FIG. 12 by the numeric designator (1).

User interaction with the result set moves information through the system. The user may take such actions as continuing through reading results, during which the user may mark the results, or rate them, may stop, or may present a new query. These actions are shown on FIG. 12 by the numeric designator (2). The knowledge web moves the results through the result-set processing system based upon such weighting as is appropriate in view of the user's actions. This weighting is indicated on FIG. 12 by the numeric designator (3). The user actions in reading the results 306 may result in additional searching 314 which produces yet additional results 316. User actions may continue to produce additional searching and additional results with effects on the weighting of the information contained in the result set. Additionally, the user profile 61 may be applied to the results and to the weighting, such that the promotion or demotion of information within the result set is a function of user profile, as well as user actions. As a result of this mechanism, information is either removed from the result set 310 or saved 320 and is ranked in the result set with regard to such features as urgency and relevancy in connection with the user query. This mechanism allows the user to be presented with information that is most relevant to the user's query.

Search Space

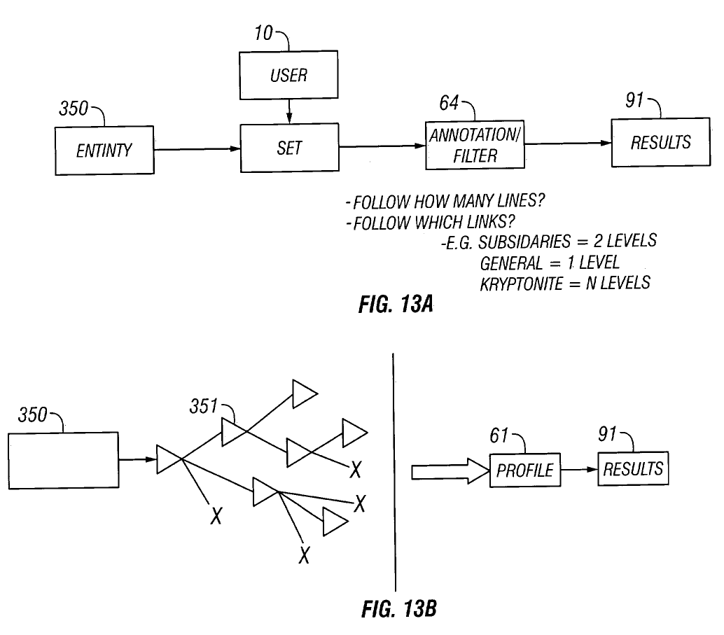

FIG. 13 illustrates the concept of search space in connection with the knowledge web. In FIG. 13a, an entity 350 such as the results of a query return from the search space is investigated. The entity may be, for example, a corporation, or a country, or any other entity. The user 10 sets various values to be applied in the entity to discover information about the entity from the universe of available information. Thus, the user might tell the knowledge web to follow a certain number of links, or to follow specific links. For example, with regard to a corporation, the user may tell the knowledge web to follow subsidiaries of the corporation, follow general reporting of the corporation, or follow a particular product made by the corporation, e.g. kryptonite. The user settings are applied to information gathered about the entity from the universe of available information through the annotation and filtering engine 64 discussed above, and the results are then provided to the user. FIG. 13b shows a two-stage search in which information about the entity from the universe of available information is first applied to an N-dimensional search space. The results derived from the search space 351 are then applied to the user profile 61 to produce the final results provided to the user.

Data Enrichment

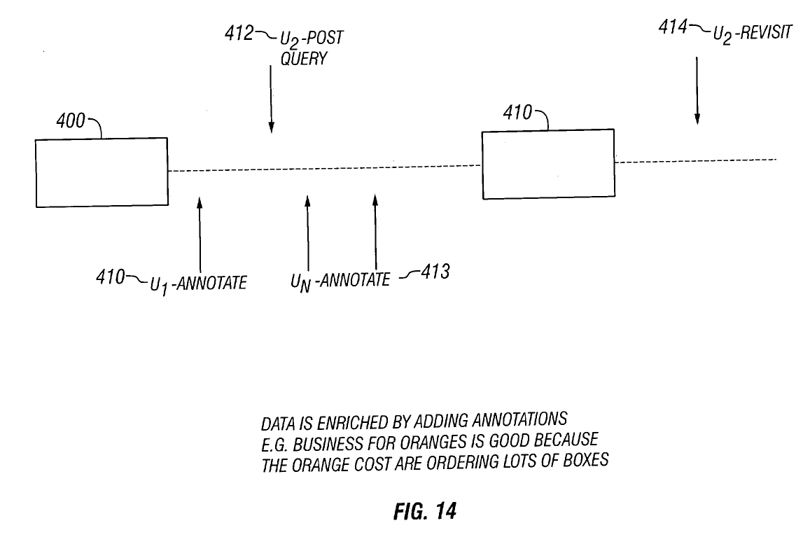

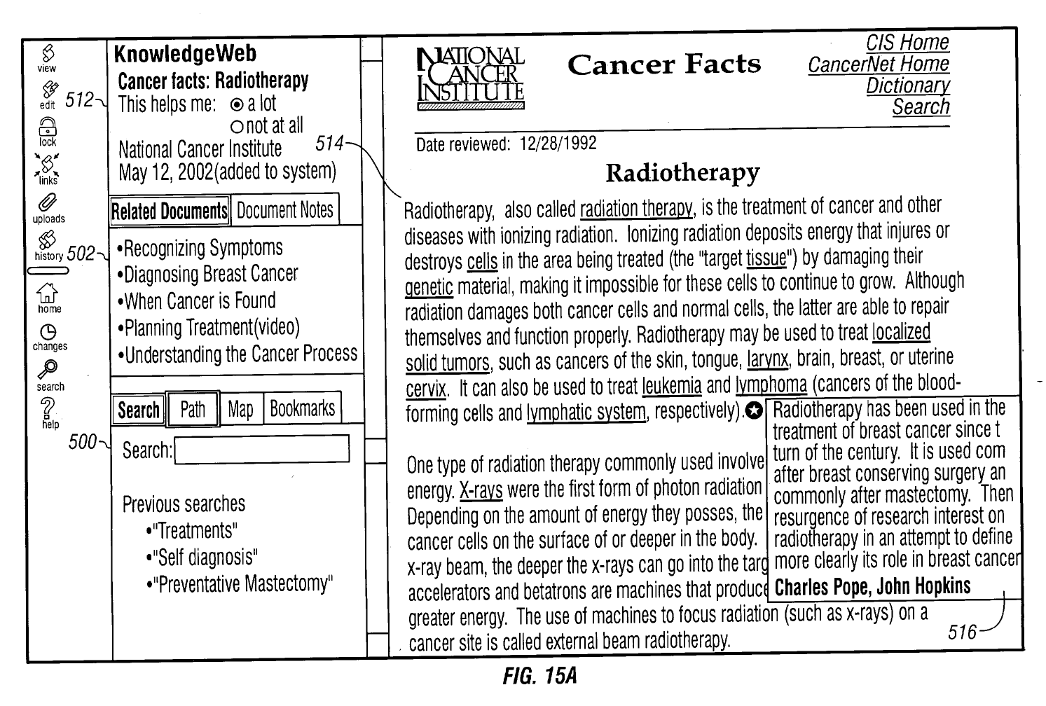

FIG. 14 illustrates the process of enriching data through the addition of annotations. In this example, data are located within the universe of available information. Such data 400 for example could be related to oranges. A first user U1 provides annotations 410 with regard to this data, at some latter point a second user U2 posts a query with regard to the information 412. Additional annotations are then provided by further users through an ultimate user Un 413. The information now exists as a collection of data about oranges and annotations 410 to that data: the information has been enriched by various annotations provided in response to the query of the user U2. At some late point in time user U2 may revisit the data 414. In this example, the interaction of various users with regard to a body of data has created a set of annotations that allows the user U2 to discover information about the data. In the case of oranges, for example, users may have provided various observations, such as “The orange companies have had good weather and expect a good crop”, or “The orange companies are ordering lots of boxes”. When a user posts a query, the results may help develop insights with regard to the information. For example, the query might be “Are the orange companies ordering new equipment?” In this case, the response might include knowledge about oranges as well as associated meta-knowledge, including the annotation, “The orange companies have ordered more machinery.” The user is able to make use of patterns of data and annotations, such as the information that the orange industry is doing very well and would be a good place to make an investment, based on the insight developed from the cumulated knowledge that the weather is good, the orange companies are ordering more boxes, and they are ordering more machinery. This information would not otherwise be available by a simple query with regard to oranges. However, the knowledge web allows users to add annotations to information in such a way that patterns and information otherwise not available through a standard search can be developed, thereby resulting in valuable insights.

Display Elements

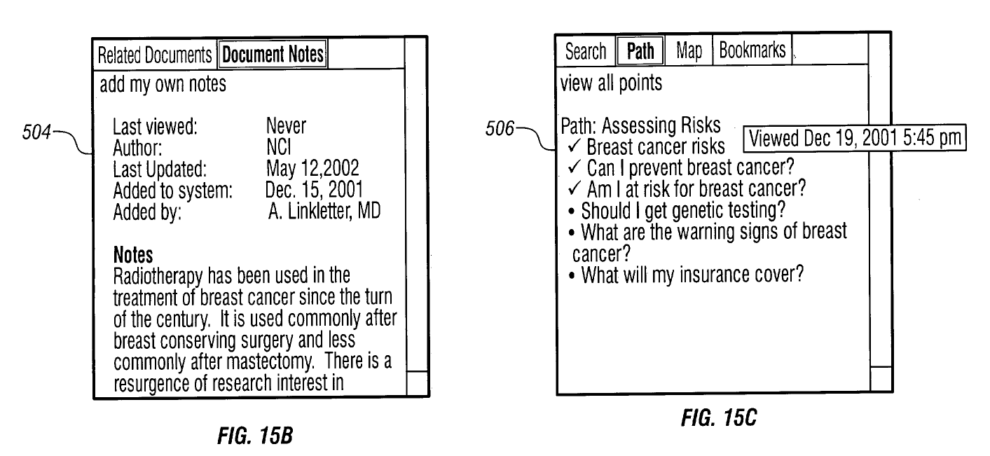

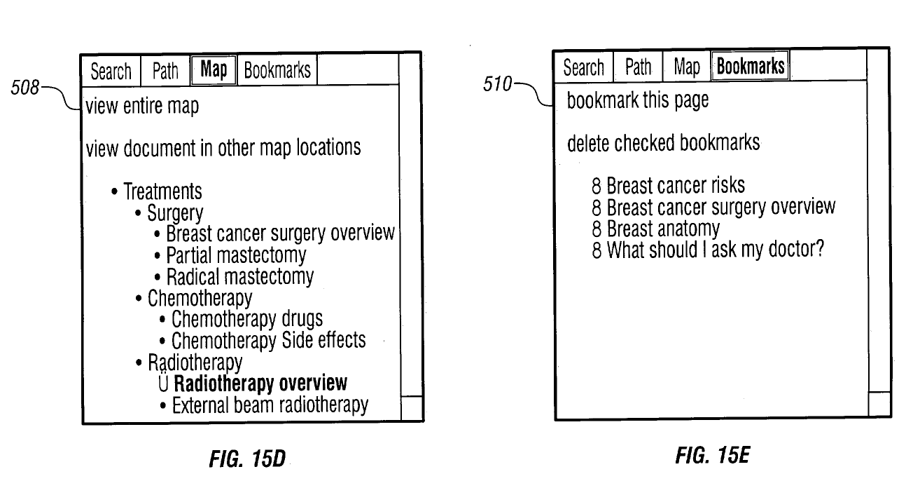

FIG. 15 is an illustration of a user interface for the knowledge web as shown on a display 78. In this example, there is a search field 500 which allows a user to enter searches and that also indicates the searcher's previous searches. There are also fields with regard to related documents 502 which allow a searcher to investigate related areas, and a field with regard to document notes 504. The user is also allowed to choose a search path, to view the document and other map locations, or to view an entire map of the documents 508 and to bookmark the information. The user is also provided with an opportunity to rate the information and thereby add his understanding of the value of the information. The actual search results are displayed to the user in the main pane 514 of the display.

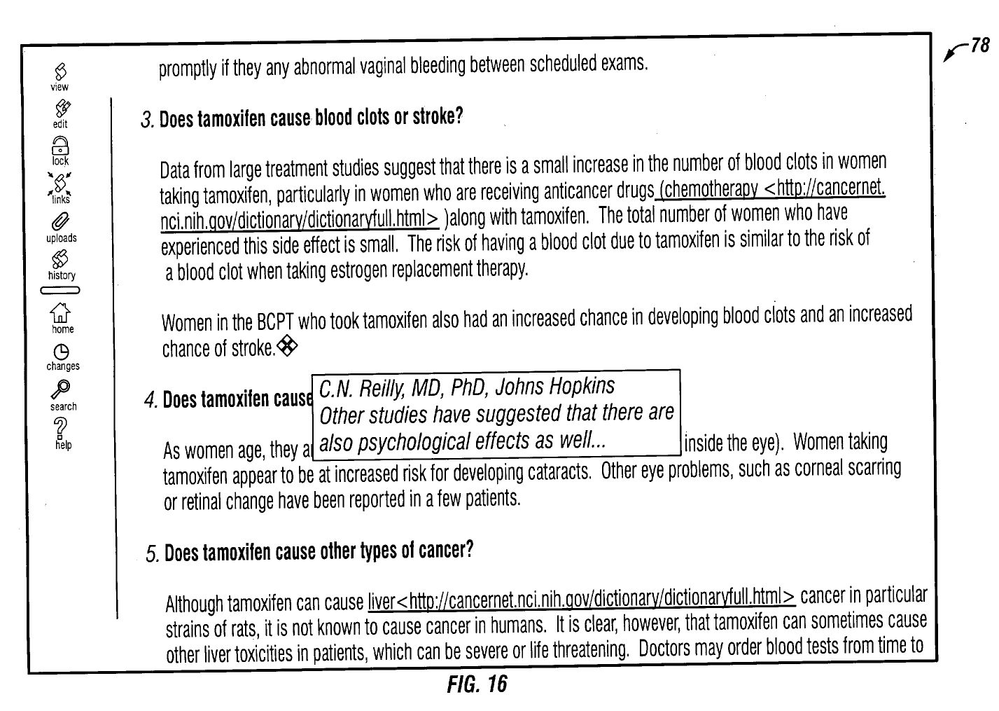

FIG. 16 shows a document fragment as presented to the user on a display 78 in context, as well as showing highlighted text from an activated comment. In the display the gray text is the part of the document that is not part of the document fragment. The document fragment text remains untouched. The highlighted text, also known as the focus, is associated with the comment mark at the end of the paragraph. In this case, the user has clicked on the comment marker, and the knowledge web client has associated text with it. When the user clicks on the comment marker, the full comment text and any follow-up comments are displayed in the side-bar. A further box is displayed when the mouse rolls over the comment marker. This shows the first few lines of the comment, giving the user enough information to decide if the comment is worth looking at in more detail. See for example FIG. 15, numeric designator 516.

Public/Private Hash Scheme

This embodiment of the invention provides a method and apparatus for authenticating the content of a distributed database that are reliable yet minimize the computational burden placed on a central registry tracking the database content. This embodiment of the invention solves the aforementioned problem by implementing a combined public and private hashing scheme to authenticate the content of a distributed database.

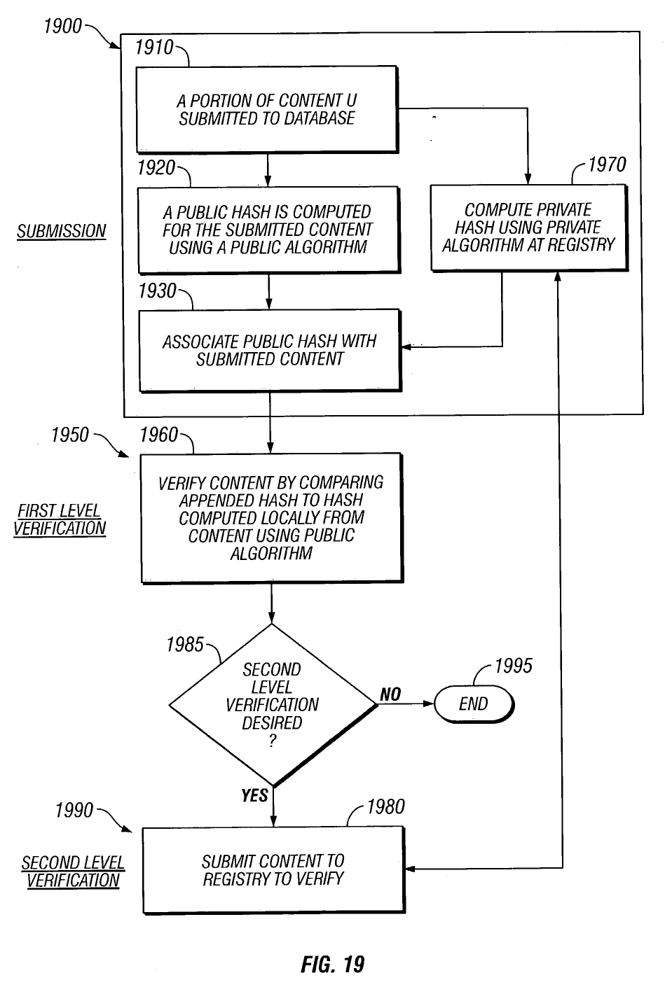

FIG. 19 is a flow diagram showing a public/private hash scheme according to the invention.

The first step is that of submission (1900).

Submission begins with calculation of the public portion of the combination hash, as performed in the prior art. When a portion of content is submitted to the database (1910), a hash is computed (1920) using a publicly distributed hashing algorithm and a publicly distributed key, if a key is needed. The computation of the hash may be performed either by the registry computer system or the computer system of the individual submitting the content, with the latter minimizing the computational demands placed on the registry computer system. Once the hash is computed, it is associated with the submitted content (1930).

The next step is first level verification (1950).

Subsequent users of the submitted content can then authenticate the content locally, by computing a hash using the publicly available algorithm, and comparing the hash obtained to the hash associated with the content (1960).

The next step is second level verification (1990).

For most instances, verification via the public algorithm provides a sufficient level of authentication. In those instances where an extra measure of authentication is desired, or if unsuccessful verification of the public hash has called the authenticity of the content into question, the authenticity of the content can be determined via a private hash.

The private hash is a second hash computed for the content upon submission to the database (1970). The specific algorithm used to compute the private hash, and any keys used by this algorithm, are known only to the registry computer system if a second level verification is desired (1985), the authenticity of the content in question is determined by resubmitting the questioned content to the registry, where a hash is computed using the private hashing algorithm, and compared with the original private hash (1980). Otherwise, the process ends (1995).

In the preferred embodiment of the invention, the aforementioned index hash serves as the public hash of the combined public and private hashing scheme. Similarly, the aforementioned cryptographically secure signature serves as the private hash. In this embodiment, both the public and private hash are stored on the registry server, but remain associated the submitted content.

Alternative Embodiments

As discussed above, the invention also contemplates the provision of feedback in connection with content. A person viewing content can rate the content, for example with regard to it's accuracy, appeal, or usefulness. In connection with this aspect of the invention, a feedback element, such as a feedback button or icon, may be incorporated into the user interface, thereby allowing a user to provide feedback. As discussed above, one simple approach to providing feedback is to provide a forward button, where selection of “forward” motion in a particular search indicates that the search is relevant. Further, selection of a “back” button indicates that the user found the displayed content relevant or use and has completed viewing the content, while selection of a “cancel” button indicates that the content was not relevant and/or not useful. The invention contemplates more elaborate schemes as well, in which the feedback button can be a slider or dipstick type arrangement, as well as other well-known user interface elements.

Another aspect of the invention contemplates the use of the knowledge web in connection with email. In particular, the knowledge web interface may be used as an email client, such that email information may be read and classified, annotated with metadata, and stored accordingly.

Another embodiment of the invention assigns context and degrees of association to content. Thus, if a particular search locates more relevant and less relevant information, then the relevance of such information may be ranked in terms of degrees of association. For example, a user may explicitly indicate which content among all content returned by a search he associates with a particular context. These degrees of association are then stored as metadata, and a subsequent search accesses such metadata to determine if the information is relevant to a specific context, based upon such degrees of association. Thus, the knowledge web accumulates information about associations based on actual user experience, where degrees of association establish a metric for determining the relevance of information to other information.

In connection with degrees of relevance or association and context for content, the knowledge web tracks both inclusionary and exclusionary information. Further, the knowledge web can apply rules and/or exceptions to rules as the basis for determining and assigning relevance to content and/or metadata. Thus, the knowledge web can provide search results that include examples of items that do not belong within the search to help establish context, as well as provide examples of items that do belong. User experience gathered as a result of user access to such information determines which information falls within the “don't belong” category and which information falls within the “do belong” category. Thus, the invention collates both negative and positive information regarding the relevance of content. For example, the rules of inclusion or exclusion may not match the user's experience. In this case such information is negative experience, or is an exception to one or more established relevance rules.

Based upon metadata and gathered and learned contextual information with regard to degrees of association and relevance, the knowledge web can suggest rules and/or can adapt rules to particular users and/or queries. The knowledge web can also suggest and adapt rules pertaining to a typical user. Developing and adapting such rules may be accomplished as described in the prior art. For example, see Winston, Patrick H. (1980), “Learning and Reasoning by Analogy”, MIT, Artificial Intelligence Laboratory Memo 520.

Further, the knowledge web may be thought of as providing collaborative associations. In this case, the knowledge web can share contexts and rules of others among users, such that user experiences from one user to another influence those of other users. Such experiences can be weighted based upon degrees of influence appropriate for each user. For example, a person who has accumulated a larger history of metadata and usage may be of greater influence, and therefore greater weight is accorded to that person's input, with regard to shaping or influencing rules than a novice user of a system. Likewise, a more highly rated user may be more influential in shaping the rules than a person having a lower rating. Additionally, the knowledge web can notice when individual users are searching for knowledge in a similar context and can recommend that the users pool or share their contextual information. In this way both the knowledge web learns from the users thereof, and the users themselves learn from each other via the knowledge web.

A further embodiment of the invention concerns annotations, as discussed above. In this embodiment invention, a mechanism is provided for assigning annotations to prove the authenticity content as well as annotations. If an annotation or criticism or other commentary is provided as an annotation under the name of a well-known person, then the signature of that person to that annotation attests to the authenticity of the annotation. In this way, the user receiving such information can rely upon such annotation as being authentic to the person making the annotation and, further, the reputation of the annotator can be protected against fraudulent use of the person's identity.

This aspect of the invention is also applicable to authenticating content, where the content may be signed, and in collaborative applications, for example the drafting of a contract where two parties must sign the contract. Annotations may be registered with the document and modifications to the document may be made, provided the modifications are certified. Thus, the invention finds application for registering such annotations and/or certifying such signatures to such annotations are already applied from various certification and non-repudiation systems known in the art. Such an approach for authenticating content and/or annotations is described above in connection with an authenticated hashing scheme.

Another aspect of the invention concerns modification and/or deletion of content and/or annotations. For example, if a user wants to correct a typographical error, this results in a new object being generated with regard to the hash code for the content. Such hashing scheme is discussed in greater detail above. In this case, the corrected object must be registered as a new object by the knowledge web. In doing so, metadata may be associated with the object to indicate that this is a corrected version of the object. In this way, a document revision history may be made in a reliable manner. Further, this embodiment of the invention may be used to register another person's comments with regard to such corrections. Thus, the content, along with the annotations may be hashed together to produce another unique object, which object may then be registered to guarantee its authenticity. In this case, the new object inherits the annotations as well as the corrected content.

One mechanism for inheriting annotations and/or corrections involves a redirection in which a knowledge web query always points to the original document and further links to a revision history, such that inherited annotations and/or corrections are provided in a single search. Another mechanism incorporates revisions by reference, such that a seamless presentation of the revision history is provided.

Another aspect of the invention provides identification when annotations are incorporated or referenced by others. Thus, the invention uniquely identifies each document and its revisions, and annotations and/or comments as unique object[s]. As well, each such object comprises metadata that identifies its relation to other objects. Thus, in the case of revisions and/or annotations, a person using the knowledge web always has access to all versions of the document because all versions of the document are registered to each other, either directly or indirectly. Further, the registry provides a mechanism for authorizing the incorporation of annotations and/or revisions. Thus, a person without the proper credentials could not create a new object having corrections. Likewise, the ability to annotate content is only available to those having verifiable identities. Thus, anonymous use of the annotation and/or correction aspects of the invention is limited, if so desired.

With regard to deletion of information, it is preferred that information never be deleted from the knowledge web. In this embodiment of the invention, all information is archived such that an audit trail is maintained with regard to each object, as well as revised versions of the object, while in other embodiments of the invention a decision may be made with regard to retention as to when to store the information, or for how long to store information.

In this scheme, information can be marked with an aging tag in the metadata that indicates the retention period for the information. Information may also be marked invalid by such metadata, such that it is not stored, or it is moved to an area in storage where all information is deemed invalid and therefore effectively deleted. In these embodiments of the invention, the registry identifies the content. Thus, even if content is removed from the system, either through failure to store or for other reasons, a record of the content having existed is preserved.

In the invention, a search to the registry of hash codes for various pages of content, metadata, and annotations is performed to determine if there are matches. Thus, a document can be identified even if it is no longer stored at its original location. In this regard, the invention provides a mechanism for registering content based on the use of a identifier, such as a hash code, only. In this regard, the content itself never need be exposed. Thus, legal documents, such as contracts and other sensitive documents that may include, for example trade secret information, can be stored in a secure manner, and yet can be verified through a public mechanism, such as the knowledge web by using the identifier, i.e. the hash code, and performing a search through the registry for documents having matching hash codes. Thus, documents may be made public for purposes of authenticating them, without actually publishing the content thereof.

Another aspect of the invention concerns the registration of hash codes. In this regard, the invention may be thought of as a mechanism for virtualizing all data and database records. Thus, records, documents and other content, metadata, and annotations may be linked without regard to their various formats by the mechanism of assigning unique identifiers within a registry system, such as that which is disclosed herein. For example, a letter may be provided in the form of text which is hashed and identified in a registry. The letter may include a link to an SQL database, which is a different format than that of the text itself. The letter and database information may be merged, for example in a customer service template, which is located at a third location in a third format. In this embodiment of the invention, the letter, database record, and template are all uniquely identified by hash codes and located in an index in the registry.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. An apparatus for authenticating content of a distributed database, comprising:
a knowledge base comprising knowledge, meta-knowledge that was created at a time of entry of said knowledge, and meta-knowledge in the form of one or more annotations that accumulate over time, said annotations including any of, but not limited to, usefulness of said knowledge, additional user opinions, certifications of veracity of said knowledge, commentary by users, and connections between said knowledge and other units of knowledge;
a user learning model comprising any of information on a user's needs, capabilities, knowledge, and preferences, said meta-knowledge stored in said knowledge base, and generalized knowledge about how people learn; and
a combined public and private hashing mechanism for authenticating said knowledge base content.

2. The apparatus of claim 1, further comprising:
a set of user tools comprising one or more tools for entering said knowledge, said meta-knowledge, and said one or more annotations into said knowledge base.

3. The apparatus of claim 1, said public and private hashing mechanism comprising:
means for submitting content to said knowledge base;
means for computing a hash on said content using a publicly distributed hashing algorithm and, optionally, a publicly distributed key; and
means for once said hash is computed, associating said hash with said submitted content.

4. The apparatus of claim 1, said public and private hashing mechanism comprising:
means for computing a second hash for said content upon submission to said knowledge base using a private hashing algorithm and, optionally any keys used by said algorithm, known only to a registry computer system.

5. The apparatus of claim 3, wherein computation of said hash is performed by any of a registry computer system and a computer system of said individual submitting said content.

6. The apparatus of claim 3, said public and private hashing mechanism further comprising:
means for performing a first level verification.

7. The apparatus of claim 6, said means for performing a first level verification comprising:
means for subsequent users of said submitted content authenticating said content locally by computing a hash using said publicly distributed hashing algorithm; and
a comparer for comparing said hash obtained to said hash associated with said content.

8. The apparatus of claim 4, said public and private hashing mechanism comprising:
means for performing a second level verification.

9. The apparatus of claim 7, said means for performing a second level verification comprising:
means for resubmitting said content to said registry;
means for computing a hash using said private hashing algorithm; and
a comparer for comparing said computed hash with said second hash.

10. The apparatus of claim 9, said public and private hashing mechanism comprising:
means for said registry computer system periodically authenticating content in said knowledge base.

11. The apparatus of claim 10, wherein said registry computer system periodically authenticates a subset of all content contained in said knowledge base.

12. A combined public and private hashing apparatus for authenticating content of a knowledge base, comprising:
means for uniquely identifying said content;
means for performing a first level verification; and
means for performing a second level verification.

13. The apparatus of claim 12, wherein said means for uniquely identifying said content comprises:
means for submitting content to said knowledge base;
means for computing a hash on said content using a publicly distributed hashing algorithm and, optionally, a publicly distributed key; and
means for once said hash is computed, associating said hash with said submitted content.

14. The apparatus of claim 13, wherein computation of said hash is performed by any of a registry computer system and a computer system of said individual submitting said content.

15. The apparatus of claim 14, said means for performing a first level verification comprises:
means for subsequent users of said submitted content authenticating said content locally by computing a hash using said publicly distributed hashing algorithm; and
a comparer for comparing said hash obtained to said hash associated with said content.

16. The apparatus of claim 12, wherein said means for performing a second level verification comprises:
means for performing a private hash.

17. The apparatus of claim 16, wherein said means for performing a private hash comprises:
means for computing a second hash for said content upon submission to said knowledge base using a private hashing algorithm and, optionally any keys used by said algorithm, known only to a registry computer system.

18. The apparatus of claim 17, wherein said means for performing a second level verification further comprises:
means for determining authenticity of said content by resubmitting said content to said registry;
means for computing a hash using said private hashing algorithm; and
a comparer for comparing said computed hash with said second hash.

19. The apparatus of claim 17, wherein said means for performing a second level verification further comprises:
means for said registry computer system periodically authenticating content in said knowledge base.

20. The apparatus of claim 19, wherein said registry computer system periodically authenticates a subset of all content contained in said knowledge base.

21. A method for authenticating content of a distributed database, comprising the steps of:
providing a knowledge base comprising knowledge, meta-knowledge that was created at a time of entry of said knowledge, and meta-knowledge in the form of one or more annotations that accumulate over time, said annotations including any of, but not limited to, usefulness of said knowledge, additional user opinions, certifications of veracity of said knowledge, commentary by users, and connections between said knowledge and other units of knowledge;
providing a user learning model comprising any of information on a user's needs, capabilities, knowledge, and preferences, said meta-knowledge stored in said knowledge base, and generalized knowledge about how people learn; and
providing a combined public and private hashing method for authenticating said knowledge base content.

22. The method of claim 21, said public and private hashing method comprising the steps of:
submitting content to said knowledge base;
computing a hash on said content using a publicly distributed hashing algorithm and, optionally, a publicly distributed key; and
once said hash is computed, associating said hash with said submitted content.

23. The method of claim 21, said public and private hashing method comprising the step of:
computing a second hash for said content upon submission to said knowledge base using a private hashing algorithm and, optionally any keys used by said algorithm, known only to a registry computer system.

24. The method of claim 22, wherein computation of said hash is performed by any of a registry computer system and a computer system of said individual submitting said content.

25. The method of claim 22, said public and private hashing method further comprising the step of:
performing a first level verification.

26. The method of claim 25, said step of performing a first level verification comprising the steps of:
subsequent users of said submitted content authenticating said content locally by computing a hash using said publicly distributed hashing algorithm; and
comparing said hash obtained to said hash associated with said content.

27. The method of claim 23, said public and private hashing method comprising the step of:
performing a second level verification.

28. The method of claim 26, said step of performing a second level verification comprising the steps of:
resubmitting said content to said registry;
computing a hash using said private hashing algorithm; and
comparing said computed hash with said second hash.

29. The method of claim 22, said public and private hashing method comprising the step of:
said registry computer system periodically authenticating content in said knowledge base.

30. The method of claim 29, wherein said registry computer system periodically authenticates a subset of all content contained in said knowledge base.

31. A combined public and private hashing method for authenticating content of a knowledge base, comprising the steps of:
uniquely identifying said content;
performing a first level verification; and
performing a second level verification.

32. The method of claim 31, wherein said step of uniquely identifying said content comprises the steps of:
submitting content to said knowledge base;
computing a hash on said content using a publicly distributed hashing algorithm and, optionally, a publicly distributed key; and
once said hash is computed, associating said hash with said submitted content.

33. The method of claim 32, wherein computation of said hash is performed by any of a registry computer system and a computer system of said individual submitting said content.

34. The method of claim 33, said step of performing a first level verification comprises the steps of:
subsequent users of said submitted content authenticating said content locally by computing a hash using said publicly distributed hashing algorithm; and
comparing said hash obtained to said hash associated with said content.

35. The method of claim 31, wherein said step of performing a second level verification comprises the step of:
performing a private hash.

36. The method of claim 35, wherein said step of performing a private hash comprises the step of:
computing a second hash for said content upon submission to said knowledge base using a private hashing algorithm and, optionally any keys used by said algorithm, known only to a registry computer system.

37. The method of claim 36, wherein said step of performing a second level verification further comprises the steps of:
determining authenticity of said content by resubmitting said content to said registry;
computing a hash using said private hashing algorithm; and
comparing said computed hash with said second hash.

38. The method of claim 36, wherein said step of performing a second level verification further comprises the step of:
said registry computer system periodically authenticating content in said knowledge base.

39. The method of claim 38, wherein said registry computer system periodically authenticates a subset of all content contained in said knowledge base.

40. The method of claim 31, wherein an index hash provides first level verification; and wherein a secure signature provides second level verification.

41. A method for providing feedback in connection with various pieces of content, comprising the steps of:
providing a feedback element comprising a “back” button; and
a user viewing said content rating said content with said feedback element;
wherein said “back” button is operable by said user to indicate any of usefulness of said content and said user's completion of said user's viewing of said content.

42. A distributed database, comprising:
a knowledge base comprising knowledge, meta-knowledge that was created at a time of entry of said knowledge, and meta-knowledge in the form of one or more annotations that accumulate over time, said annotations including any of, but not limited to, usefulness of said knowledge, additional user opinions, certifications of veracity of said knowledge, commentary by users, and connections between said knowledge and other units of knowledge;
a user learning model comprising any of information on a user's needs, capabilities, knowledge, and preferences, said meta-knowledge stored in said knowledge base, and generalized knowledge about how people learn; and
a user interface comprising an email client, wherein email information is read and classified, annotated with metadata, and stored accordingly.

43. A distributed database, comprising:
a knowledge base comprising knowledge, meta-knowledge that was created at a time of entry of said knowledge, and meta-knowledge in the form of one or more annotations that accumulate over time, said annotations including any of, but not limited to, usefulness of said knowledge, additional user opinions, certifications of veracity of said knowledge, commentary by users, and connections between said knowledge and other units of knowledge;
a user learning model comprising any of information on a user's needs, capabilities, knowledge, and preferences, said meta-knowledge stored in said knowledge base, and generalized knowledge about how people learn; and
means for assigning context and degrees of associations to knowledge.

44. The database of claim 43, said means for assigning further comprising:
means for ranking relevance of said knowledge in terms of degrees of association if a particular search locates more relevant and less relevant information.

45. The database of claim 43, wherein said degrees of association are then stored as metadata; and
wherein a search performed later on accesses said metadata to determine if said knowledge is relevant, based upon said degrees of association.

46. The database of claim 43, wherein said knowledge base accumulates information about associations based on actual user experience, and wherein said degrees of association establish a metric for determining relevance of knowledge to other knowledge.

47. The database of claim 43, wherein said knowledge base tracks both inclusionary and exclusionary information.

48. The database of claim 43, wherein said knowledge base applies any of rules and exceptions to rules as a basis for determining and assigning relevance to knowledge and/or metadata.

50. The database of claim 43, wherein said knowledge base provides search results that include examples of items that do not belong within a search to help establish context, as well as provide examples of items that do belong.

51. The database of claim 50, wherein user experience gathered as a result of user access to said knowledge determines which knowledge falls within a “do not belong” category and which knowledge falls within a “do belong” category.

52. A distributed database, comprising:
a knowledge base comprising knowledge, meta-knowledge that was created at a time of entry of said knowledge, and meta-knowledge in the form of one or more annotations that accumulate over time, said annotations including any of, but not limited to, usefulness of said knowledge, additional user opinions, certifications of veracity of said knowledge, commentary by users, and connections between said knowledge and other units of knowledge;
a user learning model comprising any of information on a user's needs, capabilities, knowledge, and preferences, said meta-knowledge stored in said knowledge base, and generalized knowledge about how people learn; and
means for providing collaborative associations for sharing contexts and rules of others among users, wherein user experiences from one user influence those of other users.

53. The database of claim 52, wherein user experiences are weighted based upon degrees of influence appropriate for each user.

54. The database of claim 52, further comprising:
means for providing notice when individual users are searching for knowledge in a similar context, and for recommending that said users pool or share their contextual information.

55. A distributed database, comprising:
a knowledge base comprising knowledge, meta-knowledge that was created at a time of entry of said knowledge, and meta-knowledge in the form of one or more annotations that accumulate over time, said annotations including any of, but not limited to, usefulness of said knowledge, additional user opinions, certifications of veracity of said knowledge, commentary by users, and connections between said knowledge and other units of knowledge;
a user learning model comprising any of information on a user's needs, capabilities, knowledge, and preferences, said meta-knowledge stored in said knowledge base, and generalized knowledge about how people learn; and
means for assigning annotations to prove authenticity.

56. The database of claim 55, wherein said means for assigning annotations to prove authenticity are used to authenticate knowledge, wherein said knowledge may be signed.

57. The database of claim 55, wherein annotations are registered with a document and modifications to said document may be made, provided said modifications are certified.

58. A distributed database, comprising:
a knowledge base comprising knowledge, meta-knowledge that was created at a time of entry of said knowledge, and meta-knowledge in the form of one or more annotations that accumulate over time, said annotations including any of, but not limited to, usefulness of said knowledge, additional user opinions, certifications of veracity of said knowledge, commentary by users, and connections between said knowledge and other units of knowledge;
a user learning model comprising any of information on a user's needs, capabilities, knowledge, and preferences, said meta-knowledge stored in said knowledge base, and generalized knowledge about how people learn; and
means for modification and/or deletion of knowledge and/or annotations;
wherein an object is generated for modified and/or deleted knowledge and/or annotations;
wherein said object must be registered as a new object by said knowledge base.

59. The database of claim 58, wherein metadata is associated with said object to indicate that the object is a corrected version of another object.

60. The database of claim 59, wherein said metadata provides a document revision history.

61. The database of claim 59, wherein said metadata is used to register another user's comments with regard to said corrections.

62. The database of claim 61, wherein said knowledge and said annotations are hashed together to produce another unique object, which object is then registered to guarantee its authenticity;
wherein said new object inherits said annotations as well as said corrected knowledge.

63. A distributed database, comprising:
a knowledge base comprising knowledge, meta-knowledge that was created at a time of entry of said knowledge, and meta-knowledge in the form of one or more annotations that accumulate over time, said annotations including any of, but not limited to, usefulness of said knowledge, additional user opinions, certifications of veracity of said knowledge, commentary by users, and connections between said knowledge and other units of knowledge;
a user learning model comprising any of information on a user's needs, capabilities, knowledge, and preferences, said meta-knowledge stored in said knowledge base, and generalized knowledge about how people learn; and
means for inheriting annotations and/or corrections comprising a redirection in which a query always points to an original document and further links to a revision history;
wherein inherited annotations and/or corrections are provided in a single search.

64. The database of claim 63, wherein revisions are inherited by reference.

65. A distributed database, comprising:
a knowledge base comprising knowledge, meta-knowledge that was created at a time of entry of said knowledge, and meta-knowledge in the form of one or more annotations that accumulate over time, said annotations including any of, but not limited to, usefulness of said knowledge, additional user opinions, certifications of veracity of said knowledge, commentary by users, and connections between said knowledge and other units of knowledge;
a user learning model comprising any of information on a user's needs, capabilities, knowledge, and preferences, said meta-knowledge stored in said knowledge base, and generalized knowledge about how people learn; and
means for providing identification when annotations are incorporated or referenced by others;
wherein each document and its revisions, and annotations and/or comments are identified as a unique object; and
wherein each such object comprises metadata that identifies its relation to other objects.

66. A distributed database, comprising:
a knowledge base comprising knowledge, meta-knowledge that was created at a time of entry of said knowledge, and meta-knowledge in the form of one or more annotations that accumulate over time, said annotations including any of, but not limited to, usefulness of said knowledge, additional user opinions, certifications of veracity of said knowledge, commentary by users, and connections between said knowledge and other units of knowledge;
a user learning model comprising any of information on a user's needs, capabilities, knowledge, and preferences, said meta-knowledge stored in said knowledge base, and generalized knowledge about how people learn; and
wherein all information is archived such that an audit trail is maintained with regard to each object, as well as revised versions of said object.

67. The database of claim 66, wherein knowledge is marked with an aging tag in said metadata that indicates a retention period for said knowledge.

68. The database of claim 66, wherein knowledge is marked invalid by said metadata, such that it is either not stored, or it is moved to an area in storage where all information is deemed invalid and therefore effectively deleted.

69. The database of claim 68, further comprising:
means for performing a search to a registry of hash codes for various pages of content, metadata, and annotations to determine if there are matches;
wherein a document can be identified even if it is no longer stored at its original location.

70. The database of claim 68, further comprising:
means for registering knowledge based on use of an identifier;
wherein said knowledge itself is not exposed; and
wherein documents may be made public for purposes of authenticating them, without actually publishing the contents thereof.

71. A distributed database, comprising:
a knowledge base comprising knowledge, meta-knowledge that was created at a time of entry of said knowledge, and meta-knowledge in the form of one or more annotations that accumulate over time, said annotations including any of, but not limited to, usefulness of said knowledge, additional user opinions, certifications of veracity of said knowledge, commentary by users, and connections between said knowledge and other units of knowledge;
a user learning model comprising any of information on a user's needs, capabilities, knowledge, and preferences, said meta-knowledge stored in said knowledge base, and generalized knowledge about how people learn; and
a registry system for virtualizing all data and database records;
wherein records, documents and other content, metadata, and annotations are linked without regard to their various formats by assigning unique identifiers within said registry system.
